(19) United States
(12) Patent Application Publication
(10) Pub. No.: US 2026/0297306 A1
(43) Pub. Date: Oct. 1, 2026

(54) ETHYLENE-BASED POLYMER COMPOSITIONS FOR TPO APPLICATIONS

(71) Applicant: Dow Global Technologies LLC, Midland, MI (US)

(72) Inventors: Yushan Hu, Pearland, TX (US); Jeffrey D. Weinhold, Lake Jackson, TX (US); Douglas S. Ginger, Houston, TX (US); Seema V. Karande, Pearland, TX (US); Yijian Lin, Pearland, TX (US); Ryan Hall, Missouri City, TX (US); Edward O. Madenjian, Lake Jackson, TX (US)

(21) Appl. No.: 19/469,432

(22) PCT Filed: Oct. 31, 2024
(86) PCT No.: PCT/US2024/053868

§ 371 Date: Sep. 26, 2025

Related U.S. Application Data
(60) Provisional application No. 63/594,753, filed on Oct. 31, 2023.

(51) Int. Cl. C08L 23/08

(52) U.S. Cl. CPC C08L 23/08

(57) ABSTRACT

1. A composition comprising the following component a): a) a first composition comprising a first ethylene/alpha-olefin interpolymer and a second ethylene/alpha-olefin interpolymer, and wherein the first composition comprises the following properties: i) a density from 0.880 to 0.910 g/cc, ii) a melt index (I2) from 0.10 to 6.0 g/10 min, and iii) a tan delta (at 190 #C, 0.1 rad/s)≤10.0.

### BACKGROUND OF THE INVENTION

Thermoplastic polyolefin (TPO) roofing membrane is a fast growing segment in commercial roofing, as compared to bitumen, PVC and EPDM. The incumbent material for the North America TPO roofing membrane market is a polypropylene TPO resin, thanks to the desired combination of heat resistance and flexibility, meaning low modulus. However, propylene-based polymers have drawbacks. Polypropylene is prone to oxidative chain scission due to its inherent chemical nature and requires specific stabilization packages to survive heat aging and UV weathering. Additionally, polypropylene-based TPO membranes, due to the high glass transition temperature of polypropylene, become brittle at low temperatures and tend to fail under high-speed impact. There is a need for TPO compositions based on more stable ethylene-based polymers, and which compositions have good heat resistance and good flexibility.

U.S. Pat. No. 10,138,362 discloses a composition comprising a first composition, which comprises at least one ethylene-based polymer, and wherein the first composition comprises a Molecular Weighted Comonomer Distribution Index (MWCDI) value greater than 0.9, and a melt index ratio 110/I2 that meets the following equation: I10/I2≥7.0−1.2×log (I2). See abstract. In one embodiment, the first composition has a density in the range of 0.910 to 0.940 g/cm³ (see column 3, lines 53-54). Experimental compositions are shown in Table 2.

U.S. Publication 2017/0129229 discloses a blown film comprising a layer formed from a composition comprising a first composition, wherein the first composition comprises at least one ethylene-based polymer and wherein the first composition comprises a MWCDI value greater than 0.9, and a melt index ratio (I10/I2) that meets the following equation: I10/I2≥7.0−1.2×log (I2). See abstract. The first composition may have a density of 0.905 to 0.935 g/cm³ (see claim 9). Experimental compositions, and properties of the same, are shown in Tables 2-14.

U.S. Publication 2015/0314511 discloses a process for producing a thermoplastic polyolefin roofing membrane. The process includes directly adding components of a high-load flame retardant TPO formulation to a counter-rotating twin screw extruder The high-load TPO formulation comprises the following: 20 wt % to 50 wt % of an olefin block copolymer; 10 wt % to 30 wt % of an ethylene/alpha-olefin copolymer; 35 wt % to 75 wt % of a flame retardant (see claim 5). In an embodiment, the ethylene/alpha-olefin copolymer has a density from 0.90 g/cc to 0.91 g/cc and a melt index from 1.0 g/10 min to 5.0 g/10 min (see paragraph)

Experimental compositions, and properties of the same, are shown in Tables 4-8.

Additional compositions are disclosed in the following references: U.S. Pat. Nos. 7,741,397, 8,372,931, 9,115,275, 9,834,712 and International Publication WO2016/127164.

However, as discussed, there remains a need for TPO compositions based on ethylene-based polymers, and which compositions have good heat resistance and good flexibility. This need has been met as discussed below.

### SUMMARY OF THE INVENTION

A composition comprising the following component a):
a) a first composition comprising a first ethylene/alpha-olefin interpolymer and a second ethylene/alpha-olefin interpolymer, and
   wherein the first composition comprises the following properties:
   i) a density from 0.880 to 0.910 g/cc,
   ii) a melt index (I2) from 0.10 to 6.0 g/10 min, and
   iii) a tan delta (at 190° C., 0.1 rad/s)≤10.0.

### BRIEF DESCRIPTION OF THE DRAWINGS

FIG. 1 depicts the “GPC MWD profile and the corresponding “comonomer (mol %) versus Log M” overlay” for first composition E, for the determination of the MWCDI.

FIG. 2 depicts the “elution temperature of iCCD” versus octene content (mol %) for the reference polymers used in the “iCCD test method.”

FIG. 3 depicts iCCD profiles for the noted first compositions A through E.

FIG. 4 depicts “GPC MWD profiles and corresponding comonomer distribution overlays” for the noted first compositions A through E.

FIG. 5 depicts DSC profiles of the noted first compositions A through E.

FIG. 6 depicts DMS profiles of the noted first compositions A through E.

FIG. 7 depicts representative example plaques to demonstrate configurations from “flat” or no thermal deformation to “severe curl (most curl)” or a high degree of thermal deformation.

### DETAILED DESCRIPTION OF THE INVENTION

New compositions have been discovered that can be used in TPO formulations that provide a good balance of heat resistance and flexibility. Such compositions are well suited for roofing applications The compositions have a broad MW split and a broad density split to achieve flexibility (low modulus), good heat resistance and good processability (high shear thinning). Also, these compositions have good miscibility/compatibility and high-density crystal dispersion.

As discussed, a composition is provided comprising the following component a):
a) a first composition comprising a first ethylene/alpha-olefin interpolymer and a second ethylene/alpha-olefin interpolymer, and
   wherein the first composition comprises the following properties:
   i) a density from 0.880 to 0.910 g/cc,
   ii) a melt index (I2) from 0.10 to 6.0 g/10 min, and
   iii) a tan delta (at 190° C., 0.1 rad/s)≤10.0.

A composition may comprise a combination of two or more embodiments, each described herein. A composition component may comprise a combination of two or more embodiments, each described herein. An ethylene/alpha-olefin interpolymer may comprise a combination of two or more embodiments, each described herein.

In one embodiment, or a combination of two or more embodiments, each described herein, the ratio of the Mw for the first ethylene/alpha-olefin interpolymer to the Mw for the second ethylene/alpha-olefin interpolymer (Mw1/Mw2)≥6.2, or ≥6.5, or ≥6.8, or ≥7.0, or ≥7.2, or ≥7.4, or ≥7.5, or ≥7.6 and/or ≤10.0, or ≤9.9, or ≤9.8, or ≤9.7, or ≤9.6, or ≤9.5, or ≤9.4, or ≤9.3, or ≤9.2, or ≤9.1.

In one embodiment, or a combination of two or more embodiments, each described herein, the ratio of the Mn for the first ethylene/alpha-olefin interpolymer to the Mn for the second ethylene/alpha-olefin interpolymer (Mn1/Mn2)≥5.0, or ≥5.5, or ≥6.0, or ≥6.2, or ≥6.4, or ≥6.6, or ≥6.8, or ≥7.0, or ≥7.2, or ≥7.4, or ≥7.6 and/or ≤10.6, or ≤10.5, or ≤10.4, or ≤10.3, or ≤10.2, or ≤10.1, or ≤10.0, or ≤9.8, or ≤9.7, or ≤9.6, or ≤9.5.

In one embodiment, or a combination of two or more embodiments, each described herein, the composition meets the following relationship: [Tm (second interpolymer)/density_{(first composition)}]≥134.0, ≥134.2, or ≥134.4, or ≥134.6, or ≥134.8, or ≥135.0 or ≥135.2, or ≥135.4, or ≥135.6, or ≥135.8, or ≥136.0, ≥136.5, or ≥136.8, or ≥137.0, or ≥137.2, or ≥137.4 or ≥137.6 (° C. cm³/g) and/or ≤140.0, or ≤139.8, or ≤139.6, or ≤139.4, or ≤139.2, or ≤139.0, or ≤138.8, or ≤138.6, or ≤138.4, or ≤138.2. (° C. cm³/g).

In one embodiment, or a combination of two or more embodiments, each described herein, the composition meets the following relationship: MWCDI≥6.0, or ≥6.2, or ≥6.5, or ≥6.8, or ≥7.0, or ≥7.2 or ≥7.5, or ≥7.8, or ≥8.0, or ≥8.1 and/or ≤20.0, or ≤18.0, or ≤16.0, or ≤15.5, or ≤15.0, or ≤14.5, or ≤14.0, or ≤13.8, or ≤13.5, or ≤13.2, or ≤13.0, or ≤12.8, or ≤12.6, or ≤12.4.

In one embodiment, or a combination of two or more embodiments, each described herein, the first composition has a molecular weight distribution (MWD=Mw/Mn)≥4.00, or ≥4.10, or ≥4.15, or ≥4.20, or ≥4.25, or ≥4.30, or ≥4.35, or ≥4.40, or ≥4.45, or ≥4.50, or ≥4.55, or ≥4.60, or ≥4.65, or ≥4.70, or ≥4.75, or ≥4.80, or ≥4.85, or ≥4.90, or ≥4.95, or ≥5.00, or ≥5.05, or ≥5.10, or ≥5.15, or ≥5.20, or ≥5.25, or ≥5.30, or ≥5.35, or ≥5.40, or ≥5.50, or ≥5.60. In one embodiment, or a combination of two or more embodiments, each described herein, the first composition has a molecular weight distribution (MWD=Mw/Mn)≤10.00, or ≤9.50, or ≤9.00, or ≤8.80, or ≤8.60, or ≤8.50, or ≤8.45, or ≤8.40, or ≤8.35, or ≤8.30, or ≤8.25, or ≤8.20, or ≤8.10, or ≤8.00, or ≤7.90.

In one embodiment, or a combination of two or more embodiments, each described herein, the first composition has a z average molecular weight (Mz)≥260,000, or ≥265,000, or ≥270,000, or ≥275,000, or ≥280,000, or ≥285,000, or ≥290,000, or ≥300,000, or ≥305,000, or ≥310,000 and/or ≤600,000, or ≤580,000, or ≤550,000, or ≤520,000, or ≤500,000, or ≤480,000, or ≤450,000, or ≤445,000, or ≤440,000, or ≤435,000, or ≤430,000, or ≤425,000, or ≤420,000, or ≤410,000, or ≤400,000 g/mol.

In one embodiment, or a combination of two or more embodiments, each described herein, the first composition has a molecular weight distribution Mz/Mw≥2.10, or ≥2.15, or ≥2.20, or ≥2.25, or ≥2.30, or ≥2.35, or ≥2.40, or ≥2.45, or ≥2.50, or ≥2.55, or ≥2.58, or ≥2.60 and/or ≤5.00, or ≤4.50, or ≤4.00, or ≤3.80, or ≤3.70, or ≤3.65, or ≤3.60, or ≤3.55, or ≤3.50, or ≤3.45, or ≤3.40, or ≤3.35, or ≤3.30, or ≤3.25, or ≤3.20.

In one embodiment, or a combination of two or more embodiments, each described herein, the first composition has a tan delta (190° C., 0.1 rad/s)≥0.80, or ≥0.90, or ≥1.00, or ≥1.10, or ≥1.20, or ≥1.30, or ≥1.40, or ≥1.50, or ≥1.60, or ≥1.80, or ≥2.00, or ≥2.10, or ≥2.20, or ≥2.30, or ≥2.40 and/or 10.0, or ≤9.5, or ≤9.0, or ≤8.5, or ≤8.0, or ≤7.9, or ≤7.8.

In one embodiment, or a combination of two or more embodiments, each described herein, the first composition is an in-reactor blend.

In one embodiment, or a combination of two or more embodiments, each described herein, the ratio of the MWD for the first ethylene/alpha-olefin interpolymer to the MWD for the second ethylene/alpha-olefin interpolymer (MWD1/MWD2) is ≥0.60, or ≥0.65, or ≥0.70, or ≥0.71, or ≥0.72, or ≥0.73, or ≥0.74, or ≥0.76, or ≥0.78, or ≥0.80, or ≥0.82, or ≥0.84, or ≥0.86 and/or ≤2.00, or ≤1.90, or ≤1.80, or ≤1.70, or ≤1.65, or ≤1.60, or ≤1.55, or ≤1.50, or ≤1.45, or ≤1.40, or ≤1.35, or ≤1.30, or ≤1.25, or ≤1.20.

In one embodiment, or a combination of two or more embodiments, each described herein, the weight ratio of the first ethylene/alpha-olefin interpolymer to the second ethylene/alpha-olefin interpolymer is ≥0.80, or ≥0.82, or ≥0.84, or ≥0.86, or ≥0.88 and/or ≤3.00, or ≤2.80, or ≤2.60, or ≤2.40, or ≤2.20, or ≤2.00, or ≤1.95, or ≤1.90, or ≤1.88, or ≤1.87.

In one embodiment, or a combination of two or more embodiments, each described herein, the difference in the density of the second ethylene/alpha-olefin interpolymer to the density of the first ethylene/alpha-olefin interpolymer (D2−D1) is ≥0.060, or ≥0.061, or ≥0.062, or ≥0.063, or ≥0.064, or ≥0.065 g/cc and/or ≤0.080, or ≤0.079, or ≤0.078, or ≤0.077, or ≤0.076, or ≤0.075, or ≤0.074, or ≤0.073, or ≤0.072 g/cc.

In one embodiment, or a combination of two or more embodiments, each described herein, the composition further comprises an ethylene/alpha-olefin interpolymer or an ethylene/alpha-olefin multi-block interpolymer, or a combination thereof, as component b.

In one embodiment, or a combination of two or more embodiments, each described herein, the ratio of the density of the first composition (component a) to the density of the ethylene/alpha-olefin multi-block interpolymer (component b) is ≥0.90, or ≥0.92, or ≥0.94, or ≥0.96, or ≥0.98, or ≥1.00, or ≥1.01, or ≥1.02 and/or ≤1.20, or ≤1.15, or ≤1.10, or ≤1.08, or ≤1.07, or ≤1.06.

In one embodiment, or a combination of two or more embodiments, each described herein, the ratio of the I2 of the component a to the I2 of component b (I2_{First Comp.}/I2_{Comp.} b) is ≥0.10, or ≥0.20, or ≥0.30, or ≥0.40, or ≥0.50, or ≥0.60, or ≥0.70, or ≥0.80, or ≥0.82, or ≥0.84, or ≥0.85, or ≥0.86 and/or ≤8.50, or ≤8.00, or ≤7.50, or ≤7.00, or ≤6.50, or ≤6.00, or ≤5.50, or ≤5.00, or ≤4.50, or ≤4.00, or ≤3.50, or ≤3.00, or ≤2.50, or ≤2.00, or ≤1.80, or ≤1.50, or ≤1.20, or ≤1.00, or ≤0.98, or ≤0.96, or ≤0.94, or ≤0.92, or ≤0.90.

In one embodiment, or a combination of two or more embodiments, each described herein, the weight ratio of component a to component b≥1.5, or ≥2.0, or ≥2.5, or ≥3.0, or ≥3.2, or ≥3.4, or ≥3.6, or ≥3.8, or ≥4.0 and/or ≤20, or ≤18, or ≤16, or ≤14, or ≤12, or ≤10, or ≤9.5, or ≤9.0 or ≤8.5, or ≤8.0, or ≤7.5, or ≤7.0.

In one embodiment, or a combination of two or more embodiments, each described herein, the composition comprises ≥50 wt %, or ≥55 wt %, or ≥60 wt %, or ≥62 wt %, or ≥64 wt %, or ≥66 wt %, or ≥68 wt %, or ≥69 wt %, or ≥70 wt %, or ≥71 wt %, or ≥72 wt % and/or ≤100 wt %, or ≤95 wt %, or ≤90 wt %, or ≤88 wt %, or ≤85 wt %, or ≤82 wt %, or ≤80 wt % of the sum of components a and b, based on the weight of the composition.

In one embodiment, or a combination of two or more embodiments, each described herein, the first composition comprises: ii) a melt index (I2) from 0.10 to 5.3 g/10 min.

In one embodiment, or a combination of two or more embodiments, each described herein, the second ethylene/alpha-olefin interpolymer has a peak iCCD temperature>80° C., or ≥82° C.

In one embodiment, or a combination of two or more embodiments, each described herein, a plaque formed from the composition, as described herein, maintains a flat planar, slight curl or more curl configuration after thermal treatment in a ventilated oven at 116° C. for one week. In one embodiment, or a combination of two or more embodiments, each described herein, a plaque formed from the composition, as described herein, maintains a flat planar or slight curl configuration, and further a flat planar configuration, after thermal treatment in a ventilated oven at 116° C. for one week.

In one embodiment, or a combination of two or more embodiments, each described herein, the composition further comprises a metal hydroxide (such as magnesium hydroxide) as component c.

In one embodiment, or a combination of two or more embodiments, each described herein, the composition further comprises at least one additive. In one embodiment, or a combination of two or more embodiments, each described herein, the at least one additive is selected from fillers (for example, carbon black, calcium carbonate, talc and clay), flow aids, antioxidants, light stabilizers, pigments (for example, titanium dioxide), colorants, processing aids (for example, zinc stearate), oils or any combination thereof.

In one embodiment, or a combination of two or more embodiments, each described herein, the composition has a heat resistance, as determined by TMA value≥114° C., or ≥115° C., or ≥116° C., or ≥117° C., or ≥118° C. and/or ≤125° C., or ≤124° C., or ≤123° C., or ≤122° C., or ≤121° C., or ≤120° C., or ≤119° C.

Also provided is an article comprising at least one component formed from the composition of any one embodiment, or a combination of two or more embodiments, each described herein. In one embodiment, or a combination of two or more embodiments, each described herein, the article is a TPO roofing membrane.

Also provided is a method of forming a TPO (thermoplastic polyolefin) composition, said method comprising mixing the composition of any one embodiment, or a combination of two or more embodiments, each described herein.

### Definitions

Unless stated to the contrary, implicit from the context, or customary in the art, all parts and percentages are based on weight, and all test methods are current as of the filing date of this disclosure.

The term “composition,” as used herein, includes a mixture of materials, which comprise the composition, as well as reaction products and decomposition products formed from the materials of the composition. Any reaction product or decomposition product is typically present in trace or residual amounts.

The term “polymer,” as used herein, refers to a polymeric compound prepared by polymerizing monomers, whether of the same or a different type. The generic term polymer thus includes the term homopolymer (employed to refer to polymers prepared from only one type of monomer, with the understanding that trace amounts of impurities can be incorporated into the polymer structure), and the term interpolymer as defined hereinafter. Trace amounts of impurities, such as catalyst residues, can be incorporated into and/or within the polymer. Typically, a polymer is stabilized with very low amounts (“ppm” amounts) of one or more stabilizers, such as one or more antioxidants.

The term “interpolymer,” as used herein, refers to a polymer prepared by the polymerization of at least two different types of monomers. The term interpolymer thus includes the term copolymer (employed to refer to polymers prepared from two different types of monomers) and polymers prepared from more than two different types of monomers.

The term “olefin-based polymer,” as used herein, refers to a polymer that comprises, in polymerized form, 50 wt % or a majority weight percent of an olefin, such as ethylene or propylene (based on the weight of the polymer), and optionally may comprise one or more comonomers.

The term “propylene-based polymer,” as used herein, refers to a polymer that comprises, in polymerized form, a majority weight percent of propylene (based on the weight of the polymer), and optionally may comprise one or more comonomers.

The term “ethylene-based polymer,” as used herein, refers to a polymer that comprises, in polymerized form, 50 wt % or a majority weight percent of ethylene (based on the weight of the polymer), and optionally may comprise one or more comonomers.

The term “ethylene/alpha-olefin interpolymer,” as used herein, refers to an interpolymer that comprises, in polymerized form, 50 wt % or a majority weight percent of ethylene (based on the weight of the interpolymer), and an alpha-olefin. The alpha-olefin is randomly distributed within the interpolymer. The term, “ethylene/alpha-olefin copolymer,” as used herein, refers to a copolymer that comprises, in polymerized form, 50 wt % or a majority amount of ethylene (based on the weight of the copolymer), and an alpha-olefin, as the only two monomer types. The alpha-olefin is randomly distributed within the copolymer.

The term “ethylene/alpha-olefin multi-block interpolymer,” as used herein, refers to a multi-block interpolymer that comprises, in polymerized form, 45 wt %, and further 50 wt %, or a majority weight percent of ethylene (based on the weight of the interpolymer), and an alpha-olefin. The term “ethylene/alpha-olefin multi-block copolymer,” as used herein, refers to a multi-block copolymer that comprises, in polymerized form, 45 wt %, and further 50 wt %, or a majority weight percent of ethylene (based on the weight of the copolymer), and an alpha-olefin, as the only two monomer types. Ethylene/alpha-olefin multi-block interpolymers are described in, for example, U.S. Pat. Nos. 7,858,706, 8,476,393 and 9,243,173, each incorporated herein by reference.

The phrase “a majority weight percent,” as used herein, in reference to a polymer (or interpolymer or copolymer), refers to the amount of monomer present in the greatest amount in the polymer.

The term “blend,” as used herein in references to polymers, refers to a composition that contains at least two polymers, such as, for example, at least two ethylene-based polymers. A blend may result from the physical blending of two or more polymers or result from an in-reactor blend. Typically, the blend contains only two polymers.

The term “in-reactor blend,” as used herein in references to polymers, refers to a composition that contains at least two polymers, such as, for example, at least two ethylene-based polymers, and where the blend is prepared during polymerization, due to the use of different catalyst systems, and/or different reactor conditions. For example, the use of two procatalysts in one reactor, during a polymerization process to form two polymers. In one embodiment, the in-reactor blend is formed from one of the following polymerizations: a) two procatalysts in one reactor; or b) a single procatalyst used in different polymerization conditions; or c) two procatalysts, each used in a different polymerization condition. Typically, the blend contains only two polymers.

The term “catalyst system,” as used herein, refers to catalyst composition comprising a procatalyst and optionally a co-catalyst.

The terms “thermally treating,” “thermally treated,” “thermal treatment,” and similar terms, as used herein, in reference to a composition as discussed herein, refer to increasing the temperature of the composition by the application of heat. As an example, heat may be applied by electrical means (for example, a heating coil in an oven) and/or by radiation and/or by hot oil and/or by mechanical shearing. Note, the temperature at which the thermal treatment takes place, refers to the temperature of the “heat-applying” device, or, if the device contains an enclosed or semi-enclosed atmosphere, the temperature of the atmosphere within the device, such as, for example, the atmosphere within an oven or a tunnel.

The terms “comprising,” “including,” “having,” and their derivatives, are not intended to exclude the presence of any additional component, step or procedure, whether the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure, not specifically delineated or listed.

### Listing of Some Composition and Process Features

A] A composition comprising the following component a):
a) a first composition comprising a first ethylene/alpha-olefin interpolymer and a second ethylene/alpha-olefin interpolymer, and
   wherein the first composition comprises the following properties:
   i) a density from 0.880 to 0.910 g/cc,
   ii) a melt index (I2) from 0.10 to 6.0 g/10 min, and
   iii) a tan delta (at 190° C., 0.1 rad/s)≤10.0.
B] The composition of A] above, wherein the ratio of the Mw for the first ethylene/alpha-olefin interpolymer to the Mw for the second ethylene/alpha-olefin interpolymer (Mw1/Mw2)≥6.2, or ≥6.5, or ≥6.8, or ≥7.0, or ≥7.2, or ≥7.4, or ≥7.5, or ≥7.6 and/or ≤10.0, or ≤9.9, or ≤9.8, or ≤9.7, or ≤9.6, or ≤9.5, or ≤9.4, or ≤9.3, or ≤9.2, or ≤9.1.
C] The composition of A] or B] above, wherein the ratio of the Mn for the first ethylene/alpha-olefin interpolymer to the Mn for the second ethylene/alpha-olefin interpolymer (Mn1/Mn2)≥5.0, or ≥5.5, or ≥6.0, or ≥6.2, or ≥6.4, or ≥6.6, or ≥6.8, or ≥7.0, or ≥7.2, or ≥7.4, or ≥7.6 and/or ≤10.6, or ≤10.5, or ≤10.4, or ≤10.3, or ≤10.2, or ≤10.1, or ≤10.0, or ≤9.8, or ≤9.7, or ≤9.6, or ≤9.5.
D] The composition of any one of A]-C] (A] through C]) above, wherein the composition meets the following relationship: [Tm_{(second interpolymer)}/density_{(first composition)}]≥134.0, ≥134.2, or ≥134.4, or ≥134.6, or ≥134.8, or ≥135.0 or ≥135.2, or ≥135.4, or ≥135.6, or ≥135.8, or ≥136.0, ≥136.5, or ≥136.8, or ≥137.0, or ≥137.2, or ≥137.4 or ≥137.6 (° C. cm³/g) and/or ≤140.0, or ≤139.8, or ≤139.6, or ≤139.4, or ≤139.2, or ≤139.0, or ≤138.8, or ≤138.6, or ≤138.4, or ≤138.2. (° C. cm³/g).
E] The composition of any one of A]-D] above, wherein the composition meets the following relationship: MWCDI≥6.0, or ≥6.2, or ≥6.5, or ≥6.8, or ≥7.0, or ≥7.2 or ≥7.5, or ≥7.8, or ≥8.0, or ≥8.1 and/or ≤20.0, or ≤18.0, or ≤16.0, or ≤15.5, or ≤15.0, or ≤14.5, or ≤14.0, or ≤13.8, or ≤13.5, or ≤13.2, or ≤13.0, or ≤12.8, or ≤12.6, or ≤12.4.
F] The composition of any one of A]-E] above, wherein the first composition has a density≥0.882 g/cc, or ≥0.883 g/cc, or, or ≥0.884 g/cc, or ≥0.885 g/cc, or ≥0.886 g/cc, or ≥0.888 g/cc, or ≥0.890 g/cc, or ≥0.892 g/cc, or ≥0.893 g/cc, or ≥0.894 g/cc, or ≥0.895 g/cc, or ≥0.896 g/cc, or ≥0.897 g/cc, or ≥0.898 g/cc, or ≥0.899 g/cc, or ≥0.900 g/cc, or ≥0.901 g/cc (1 cc=1 cm³).
G] The composition of any one of A]-F] above, wherein the first composition has a density≤0.908 g/cc, or ≤0.906 g/cc, or ≤0.904 g/cc, or ≤0.903 g/cc, or ≤0.902 g/cc.
H] The composition of any one of A]-G] above, wherein the first composition has a melt index (I2)≥0.20, or ≥0.30, or ≥0.40, or ≥0.50, or ≥0.55, or ≥0.60, or ≥0.65, or ≥0.70, or ≥0.75, or ≥0.80, or ≥0.82, or ≥0.84, or ≥0.85, or ≥0.86 g/10 min.
I] The composition of any one of A]-H] above, wherein the first composition has a melt index (I2)≤5.8, or ≤5.6, or ≤5.4, or ≤5.3, or ≤5.2, or ≤5.0, or ≤4.8, or ≤4.5, or ≤4.2, or ≤4.0, or ≤3.5, or ≤3.0, or ≤2.5, or ≤2.0, or ≤1.8, or ≤1.6, or ≤1.4, or ≤1.2, or ≤1.0, or ≤0.98, or ≤0.96, or ≤0.94, or ≤0.92, or ≤0.91, or ≤0.90 g/10 min.
J] The composition of any one of A]-I] above, wherein the first composition has a I10/I2 ratio≥7.0, or ≥7.5, or ≥8.0, or ≥8.5, or ≥9.0, and/or ≤22.0, or ≤21.0, or ≤20.0, or ≤19.5, or ≤19.0 or ≤18.5.
K] The composition of any one of A]-J] above, wherein the first composition has a molecular weight distribution (MWD=Mw/Mn)≥4.00, or ≥4.10, or ≥4.15, or ≥4.20, or ≥4.25, or ≥4.30, or ≥4.35, or ≥4.40, or ≥4.45, or ≥4.50, or ≥4.55, or ≥4.60, or ≥4.65, or ≥4.70, or ≥4.75, or ≥4.80, or ≥4.85, or ≥4.90, or ≥4.95, or ≥5.00, or ≥5.05, or ≥5.10, or ≥5.15, or ≥5.20, or ≥5.25, or ≥5.30, or ≥5.35, or ≥5.40, or ≥5.50, or ≥5.60.
L] The composition of any one of A]-K] above, wherein the first composition has a molecular weight distribution (MWD=Mw/Mn)≤10.00, or ≤9.50, or ≤9.00, or ≤8.80, or ≤8.60, or ≤8.50, or ≤8.45, or ≤8.40, or ≤8.35, or ≤8.30, or ≤8.25, or ≤8.20, or ≤8.10, or ≤8.00, or ≤7.90.
M] The composition of any one of A]-L] above, wherein the first composition has a number average molecular weight (Mn)≥12,000, or ≥13,000, or ≥13,500, or ≥14,000, or ≥14,500, or ≥15,000, or ≥15,500, or ≥16,000 g/mol and/or ≤50,000, or ≤40,000, or ≤35,000, or ≤30,000, or ≤29,000, or ≤26,000, or ≤24,000, or ≤23,000, or ≤22,000 g/mol.
N] The composition of any one of A]-M] above, wherein the first composition has a weight average molecular weight (Mw)≥100,000, or ≥105,000, or ≥110,000, or ≥112,000, or ≥114,000, or ≥116,000, or ≥118,000 and/or ≤250,000, or ≤200,000, or ≤150,000, or ≤145,000, or ≤140,000, or ≤135,000, or ≤130,000, or ≤128,000, or ≤126,000, or ≤124,000 g/mol.
O] The composition of any one of A]-N] above, wherein the first composition has a z average molecular weight (Mz)≥260,000, or ≥265,000, or ≥270,000, or ≥275,000, or ≥280,000, or ≥285,000, or ≥290,000, or ≥300,000, or ≥305,000, or ≥310,000 and/or ≤600,000, or ≤580,000, or ≤550,000, or ≤520,000, or ≤500,000, or ≤480,000, or ≤450,000, or ≤445,000, or ≤440,000, or ≤435,000, or ≤430,000, or ≤425,000, or ≤420,000, or ≤410,000, or ≤400,000 g/mol.
P] The composition of any one of A]-O] above, wherein the first composition has a molecular weight distribution Mz/Mw≥2.10, or ≥2.15, or ≥2.20, or ≥2.25, or ≥2.30, or ≥2.35, or ≥2.40, or ≥2.45, or ≥2.50, or ≥2.55, or ≥2.58, or ≥2.60.
Q] The composition of any one of A]-P] above, wherein the first composition has a molecular weight distribution Mz/Mw≤5.00, or ≤4.50, or ≤4.00, or ≤3.80, or ≤3.70, or ≤3.65, or ≤3.60, or ≤3.55, or ≤3.50, or ≤3.45, or ≤3.40, or ≤3.35, or ≤3.30, or ≤3.25, or ≤3.20.
R] The composition of any one of A]-Q] above, wherein the first composition has a melting point (Tm)≥116.0° C., or ≥118.0° C., or ≥120.0° C., or ≥121.0° C., or ≥122.0° C., or ≥122.5° C., or ≥123.0° C., or ≥123.5° C., or ≥124.0° C. and/or ≤130.0° C., or ≤128.0° C., or ≤126.0° C., or ≤125.8° C., or ≤125.5° C., or ≤125.2° C., or ≤125.0° C., or ≤124.8° C., or ≤124.5° C., as determined by DSC.
S] The composition of any one of A]-R] above, wherein the first composition has a percent crystallinity (% cryst.)≥25.0%, or ≥30.0%, or ≥32.0%, or ≥34.0%, or ≥36.0%, or ≥38.0%, or ≥38.2%, or ≥38.4%, or ≥38.6%, or ≥38.8%, or ≥38.9% and/or ≤50.0%, or ≤48.0%, or ≤46.0%, or ≤44.0%, or ≤42.0%, or ≤41.0%, or ≤40.0%, or ≤39.0%, as determined by DSC.
T] The composition of any one of A]-S] above, wherein the first composition has a tan delta (190° C., 0.1 rad/s)≥0.80, or ≥0.90, or ≥1.00, or ≥1.10, or ≥1.20, or ≥1.30, or ≥1.40, or ≥1.50, or ≥1.60, or ≥1.80, or ≥2.00, or ≥2.10, or ≥2.20, or ≥2.30, or ≥2.40 and/or 10.0, or ≤9.5, or ≤9.0, or ≤8.5, or ≤8.0, or ≤7.9, or ≤7.8.
U] The composition of any one of A]-T] above, wherein the first composition has a viscosity V0.1 (190° C., 0.1 rad/s)≥9,000, or ≥9,500, or ≥10,000, or ≥10,500, or ≥11,000 Pa·s and/or ≥60,000, or ≥58,000, or ≥55,000, or ≥52,000, or ≥50,000, or ≥45,000, or ≥40,000, or ≥35,000, or ≥30,000, or ≥25,000, or ≤20,000, or ≤19,000, or ≤18,000, or ≤17,500, or ≤17,000, or ≤16,500, or ≤16,000 Pa·s.
V] The composition of any one of A]-U] above, wherein the first composition has a viscosity V100 (190° C., 100 rad/s)≥600, or ≥650, or ≥700, or ≥750, or ≥800 Pa's and/or ≤2,000, or ≤1,800, or ≤1,600, or ≤1,500 Pa·s.
W] The composition of any one of A]-V] above, wherein the first composition has a viscosity ratio V0.1/V100 (each at 190° C.)≥6.0, or ≥6.2, or ≥6.4, or ≥6.6, or ≥6.8, or ≥7.0, or ≥7.2, or ≥7.4, or ≥7.5 and/or ≤50.0, or ≤45.0, or ≤40.0, or ≤38.0, or ≤36.0, or ≤34.0, or ≤32.0, or ≤30.0, or ≤28.0, or ≤26.0, or ≤24.0, or ≤22.0, or ≤20.0, or ≤19.5, or ≤19.0, or ≤18.5, or ≤18.0, or ≤17.5.
X] The composition of any one of A]-W] above, wherein the first composition has a TMA value (heat resistance)≥114° C., or ≥115° C., or ≥116° C. and/or ≤125° C., or ≤124° C., or ≤123° C., or ≤122° C., or ≤121° C., or ≤120° C., or ≤119° C.
Y] The composition of any one of A]-X] above, wherein the first composition has a Microtensile Modulus≥86, or ≥87, or ≥88, or ≥89 MPa and/or ≤106, or ≤104, or ≤102, or ≤101 MPa.
Z] The composition of any one of A]-Y] above, wherein the first composition is an in-reactor blend.
A2] The composition of any one of A]-Z] above, wherein the alpha-olefin of the first ethylene/alpha-olefin interpolymer is a C3-C20 alpha-olefin, and further a C3-C10 alpha-olefin, and further a C3-C8 alpha-olefin.
B2] The composition of any one of A]-A2] above, wherein the alpha-olefin of the first ethylene/alpha-olefin interpolymer is propylene, 1-butene, 1-hexene or 1-octene, further propylene, 1-butene, or 1-octene, further 1-butene or 1-octene, further 1-octene.
C2] The composition of any one of A]-B2] above, wherein the alpha-olefin of the second ethylene/alpha-olefin interpolymer is a C3-C20 alpha-olefin, and further a C3-C10 alpha-olefin, and further a C3-C8 alpha-olefin.
D2] The composition of any one of A]-C2] above, wherein the alpha-olefin of the second ethylene/alpha-olefin interpolymer is propylene, 1-butene, 1-hexene or 1-octene, further propylene, 1-butene, or 1-octene, further 1-butene or 1-octene, further 1-octene.
E2] The composition of any one of A]-D2] above, wherein the alpha-olefin of the first interpolymer and the alpha-olefin of the second interpolymer are the same.
F2] The composition of any one of A]-E2] above, wherein the first ethylene/alpha-olefin interpolymer is an ethylene/alpha-olefin copolymer.
G2] The composition of any one of A]-F2] above, wherein the second ethylene/alpha-olefin interpolymer is an ethylene/alpha-olefin copolymer.
H2] The composition of any one of A]-G2] above, wherein the first ethylene/alpha-olefin interpolymer has a weight average molecular weight (Mw)≥150,000, or ≥155,000, or ≥165,000, or ≥160,000, or ≥162,000 g/mol, or ≥164,000, or ≥166,000, or ≥168,000, or ≥169,000, or ≥170,000 g/mol and/or ≤350,000, or ≤300,000, or ≤290,000, or ≤280,000, or ≤260,000, or ≤250,000, or ≤240,000, or ≤238,000, or ≤236,000, or ≤234,000, or ≤232,000 g/mol.
I2] The composition of any one of A]-H2] above, wherein the second ethylene/alpha-olefin interpolymer has a weight average molecular weight (Mw)≥16,000, or ≥16,500, or ≥17,000, or ≥17,500, or ≥18,000 or ≥18,500, or ≥19,000 g/mol and/or ≤60,000, or ≤55,000, or ≤50,000, or ≤45,000, or ≤40,000, or ≤38,000, or ≤36,000, or ≤34,000, or ≤32,000 g/mol.
J2] The composition of any one of A]-[2] above, wherein the first ethylene/alpha-olefin interpolymer has a number average molecular weight (Mn)≥40,000, or ≥45,000, or ≥50,000, or ≥52,000, or ≥55,000 g/mol, or ≥58,000, or ≥60,000, or ≥62,000, or ≥64,000, or ≥66,000, or ≥68,000 g/mol and/or ≤150,000, or ≤140,000, or ≤130,000, or ≤120,000, or ≤110,000, or ≤100,000, or ≤98,000, or ≤96,000, or ≤94,000, or ≤92,000, or ≤90,000 g/mol.
K2] The composition of any one of A]-J2] above, wherein the second ethylene/alpha-olefin interpolymer has a number average molecular weight (Mn)≥4,000, or ≥5,000, or ≥6,000, or ≥7,000, or ≥7,500 g/mol, or ≥8,000, or ≥8,200, or ≥8,400, or ≥8,600, or ≥8,700 ≥8,800 g/mol and/or ≤50,000, or ≤40,000, or ≤35,000, or ≤30,000, or ≤25,000, or ≤20,000, or ≤18,000, or ≤15,000, or ≤12,000, or ≤10,000, or ≤9,800 g/mol.
L2] The composition of any one of A]-K2] above, wherein the first ethylene/alpha-olefin interpolymer has a molecular weight distribution (MWD=Mw/Mn)≥2.00, or ≥2.05, or ≥2.10, or ≥2.15, or ≥2.20, or ≥2.25, or ≥2.30, or ≥2.35, or ≥2.40, or ≥2.45 and/or ≤3.00, or ≤2.95, or ≤2.90, or ≤2.85, or ≤2.80.
M2] The composition of any one of A]-L2] above, wherein the second ethylene/alpha-olefin interpolymer has a molecular weight distribution (MWD=Mw/Mn)≥1.80, or ≥1.85, or ≥1.90, or ≥1.95, or ≥2.00, or ≥2.05, or ≥2.10, or ≥2.14 and/or ≤3.50, or ≤3.45, or ≤3.40, or ≤3.35, or ≤3.30, or ≤3.25, or ≤3.20, or ≤3.15.
N2] The composition of any one of A]-M2] above, wherein the ratio of the MWD for the first ethylene/alpha-olefin interpolymer to the MWD for the second ethylene/alpha-olefin interpolymer (MWD1/MWD2) is ≥0.60, or ≥0.65, or ≥0.70, or ≥0.71, or ≥0.72, or ≥0.73, or ≥0.74, or ≥0.76, or ≥0.78, or ≥0.80, or ≥0.82, or ≥0.84, or ≥0.86 and/or ≤2.00, or ≤1.90, or ≤1.80, or ≤1.70, or ≤1.65, or ≤1.60, or ≤1.55, or ≤1.50, or ≤1.45, or ≤1.40, or ≤1.35, or ≤1.30, or ≤1.25, or ≤1.20.

O2] The composition of any one of A]-N2] above, wherein the first composition comprises ≥40 wt %, or ≥42 wt %, or ≥43 wt %, or ≥44 wt %, or ≥45 wt %, or ≥46 wt %, or ≥47 wt % of the first interpolymer and/or ≤80 wt %, or ≤75 wt %, or ≤70 wt %, or ≤69 wt %, or ≤68 wt %, or ≤67 wt %, or ≤66 wt %, or ≤65 wt % of the first interpolymer, based on the weight of the first composition.
P2] The composition of any one of A]-02] above, wherein the first composition comprises ≥20 wt %, or ≥25 wt %, or ≥28 wt %, or ≥30 wt %, or ≥31 wt %, or ≥32 wt %, or ≥33 wt %, or ≥34 wt %, or ≥35 wt % of the second interpolymer and/or ≤60 wt %, or ≤58 wt %, or ≤57 wt %, or ≤56 wt %, or ≤55 wt %, or ≤54 wt %, or ≤53 wt % of the second interpolymer, based on the weight of the first composition.
Q2] The composition of any one of A]-02] above, wherein the weight ratio of the first ethylene/alpha-olefin interpolymer to the second ethylene/alpha-olefin interpolymer≥0.80, or ≥0.82, or ≥0.84, or ≥0.86, or ≥0.88, or ≥0.90, or ≥0.92, or ≥0.94 and/or ≤3.00, or ≤2.80, or ≤2.60, or ≤2.40, or ≤2.20, or ≤2.00, or ≤1.95, or ≤1.90, or ≤1.88, or ≤1.87.
R2] The composition of any one of A]-Q2] above, wherein the difference in the density of the second ethylene/alpha-olefin interpolymer to the density of the first ethylene/alpha-olefin interpolymer (D2-D1)≥0.060, or ≥0.061, or ≥0.062, or ≥0.063, or ≥0.064, or ≥0.065 g/cc and/or ≤0.080, or ≤0.079, or ≤0.078, or ≤0.077, or ≤0.076, or ≤0.075, or ≤0.074, or ≤0.073, or ≤0.072 g/cc.
S2] The composition of any one of A]-R2] above, wherein the first ethylene/alpha-olefin interpolymer has a density≥0.860 g/cc, or ≥0.862 g/cc, or ≥0.865 g/cc, or ≥0.868 g/cc, or ≥0.869 g/cc, or ≥0.870 g/cc and/or ≤0.882 g/cc, or ≤0.881 g/cc, or ≤0.880 g/cc, or ≤0.879 g/cc, or ≤0.878 g/cc (1 cc=1 cm³).
T2] The composition of any one of A]-S2] above, wherein the second ethylene/alpha-olefin interpolymer has a density≥0.930 g/cc, or ≥0.931 g/cc, or ≥0.932 g/cc, or ≥0.933 g/cc, or ≥0.934 g/cc, or ≥0.935 g/cc and/or ≤0.955 g/cc, or ≤0.954 g/cc, or ≤0.953 g/cc, or ≤0.952 g/cc, or ≤0.951 g/cc, or ≤0.950 g/cc (1 cc=1 cm³).
U2] The composition of any one of A]-T2] above, wherein the first ethylene/alpha-olefin interpolymer has a melt index (I2)≥0.020, or ≥0.040, or ≥0.060, or ≥0.080, or ≥0.100, or ≥0.110, or ≥0.120, or ≥0.130, or ≥0.140, or ≥0.150 g/10 min and/or ≤0.500, or ≤0.400, or ≤0.350, or ≤0.300, or ≤0.280, or ≤0.260, or ≤0.250, or ≤0.240, or ≤0.235, or ≤0.230, or ≤0.225 g/10 min.
V2] The composition of any one of A]-U2] above, wherein the ratio of the I2 of the first composition to the I2 of the first ethylene/alpha-olefin interpolymer (I2_{First Comp.}/I2_{First Interpolymer})≥2.0, or ≥2.2, or ≥2.4, or ≥2.6, or ≥2.8, or ≥3.0, or ≥3.2, or ≥3.4, or ≥3.6 and/or ≤7.0, or ≤6.8, or ≤6.6, or ≤6.4, or ≤6.2, or ≤6.0, or ≤5.8.
W2] The composition of any one of A]-V2] above, wherein the ratio of the density of the first composition to the density of the first ethylene/alpha-olefin interpolymer (D_{First Comp.}/D_{First Interpolymer})≥1.00, or ≥1.01, or ≥1.02, or ≥1.03 and/or ≤1.10, or ≤1.08, or ≤1.07, or ≤1.06, or ≤1.05, or ≤1.04.
X2] The composition of any one of A]-W2] above, wherein the ratio of the Mn for the first composition to the Mn for the first ethylene/alpha-olefin interpolymer (Mn_{First Comp.}/Mn1)≥0.100, or ≥0.120, or ≥0.140, or ≥0.160, or ≥0.180, or ≥0.185, or ≥0.190, or ≥0.192 and/or ≤0.500, or ≤0.450, or ≤0.400, or ≤0.370, or ≤0.350, or ≤0.320, or ≤0.318, or ≤0.316, or ≤0.314, or ≤0.312, or ≤0.310.
Y2] The composition of any one of A]-X2] above, wherein the ratio of the Mw for the first composition to the Mw for the first ethylene/alpha-olefin interpolymer (MW_{First Comp.}/Mw1)≥0.400, or ≥0.445, or ≥0.500, or ≥0.510, or ≥0.520, or ≥0.525, or ≥0.530, or ≥0.535 and/or ≤1.00, or ≤0.950, or ≤0.900, or ≤0.850, or ≤0.800, or ≤0.750, or ≤0.700, or ≤0.695.
Z2] The composition of any one of A]-Y2] above, wherein the ratio of the MWD for the first composition to the MWD for the first ethylene/alpha-olefin interpolymer (MWD_{First Comp.}/MWD1)≥1.6, or ≥1.7, or ≥1.8, or ≥1.9, or ≥2.0, or ≥2.1, or ≥2.2, or ≥2.3 and/or ≤3.2, or ≤3.1, or ≤3.0, or ≤2.9, or ≤2.8.
A3] The composition of any one of A]-Z2] above, wherein the first composition comprises ≥50 wt %, or ≥80 wt %, or ≥82 wt %, or ≥85 wt %, or ≥88 wt %, or ≥90 wt %, or ≥92 wt %, or ≥94 wt %, or ≥96 wt %, or ≥98 wt % and/or ≤100 wt %, or ≤99 wt % of the sum of the first interpolymer and the second interpolymer, based on the weight of the first composition. B3] The composition of any one of A]-A3] above, wherein the composition has a V0.1/V100 ratio ≥6.0, or ≥6.2, or ≥6.4, or ≥6.6, or ≥6.8, or ≥7.0, or ≥7.2, or ≥7.4 and/or ≤40.0, or ≤35.0, or ≤30.0, or ≤25.0, or ≤20.0, or ≤19.0, or ≤18.5, or ≤18.0, or ≤17.8 or ≤17.6.
C3] The composition of any one of A]-A3] above, wherein the composition has a Tan Delta (190° C., 0.1 rad/s)≥1.0, or ≥1.2, or ≥1.4, or ≥2.0, or ≥2.2, or ≥2.4 and/or ≤10.0, or ≤9.0, or ≤8.5, or ≤8.0.
D3] The composition of any one of A]-C3] above, wherein the composition further comprises a thermoplastic polymer, different from the first interpolymer and the second interpolymer of component a in one or more features, such as monomer(s) types, distributions and/or amounts, density, melt index (I2), Mn, Mw, MWD, or any combination thereof, and further, in one or more features, such as monomer(s) types, distributions and/or amounts, density, melt index or any combination thereof.
E3] The composition of D3] above, wherein the composition further comprises an ethylene/alpha-olefin interpolymer or an ethylene/alpha-olefin multi-block interpolymer, or a combination thereof, as component b.
F3] The composition of E3] above, wherein the composition further comprises an ethylene/alpha-olefin multi-block interpolymer as component b.
G3] The composition of E3] or F3] above, wherein the alpha-olefin of the ethylene/alpha-olefin multi-block interpolymer (component b) is a C3-C20 alpha-olefin, further a C3-C10 alpha-olefin, further a C3-C8 alpha-olefin, further propylene, 1-butene, 1-hexene or 1-octene, further propylene, 1-butene, or 1-octene, further 1-butene or 1-octene, further 1-octene.
H3] The composition of any one of E3]-G3] above, wherein the alpha-olefin of the ethylene/alpha-olefin multi-block interpolymer (component b) is the same as the alpha-olefin of the first ethylene/alpha-olefin interpolymer and the alpha-olefin of the second ethylene/alpha-olefin interpolymer of the first composition (component a).
I3] The composition of any one of E3]-H3] above, wherein the ethylene/alpha-olefin multi-block interpolymer is an ethylene/alpha-olefin multi-block copolymer.
J3] The composition of any one of E3]-13] above, wherein component b has a density≥0.855 g/cc, or ≥0.860 g/cc, or ≥0.861 g/cc, or ≥0.862 g/cc, or ≥0.863 g/cc, or ≥0.864 g/cc, or ≥0.865 g/cc, or ≥0.866 g/cc (1 cc=1 cm³) and/or ≤0.890 g/cc, or ≤0.885 g/cc, or ≤0.880 g/cc, or ≤0.878 g/cc, or ≤0.876 g/cc, or ≤0.874 g/cc, or ≤0.872 g/cc, or ≤0.870 g/cc.
K3] The composition of any one of E3]-J3] above, wherein component b has a melt index (I2)≥0.50, or ≥0.60, or ≥0.70, or ≥0.80, or ≥0.82, or ≥0.85, or ≥0.88, or ≥0.90, or ≥0.92, or ≥0.94, or ≥0.96, or ≥0.98 g/10 min and/or ≤1.20, or ≤1.18, or ≤1.15, or ≤1.12, or ≤1.10, or ≤1.07, or ≤1.05, or ≤1.02, or ≤1.00 g/10 min.
L3] The composition of any one of E3]-K3] above, wherein the ratio of the density of the first composition (component a) to the density of the ethylene/alpha-olefin multi-block interpolymer (component b) is ≥0.90, or ≥0.92, or ≥0.94, or ≥0.96, or ≥0.98, or ≥1.00, or ≥1.01, or ≥1.02 and/or ≤1.20, or ≤1.15, or ≤1.10, or ≤1.08, or ≤1.07, or ≤1.06.
M3] The composition of any one of E3]-L3] above, wherein the ratio of the I2 of the component a to the I2 of component b (I2_{First Comp.}/I2_{Comp.} b)≥0.10, or ≥0.20, or ≥0.30, or ≥0.40, or ≥0.50, or ≥0.60, or ≥0.70, or ≥0.80, or ≥0.82, or ≥0.84, or ≥0.85, or ≥0.86 and/or ≤8.50, or ≤8.00, or ≤7.50, or ≤7.00, or ≤6.50, or ≤6.00, or ≤5.50, or ≤5.00, or ≤4.50, or ≤4.00, or ≤3.50, or ≤3.00, or ≤2.50, or ≤2.00, or ≤1.80, or ≤1.50, or ≤1.20, or ≤1.00, or ≤0.98, or ≤0.96, or ≤0.94, or ≤0.92, or ≤0.90.
N3] The composition of any one of E3]-M3] above, wherein the composition comprises ≥8.0 wt %, or ≥9.0 wt %, or ≥10 wt %, or ≥11 wt %, or ≥12 wt %, or ≥13 wt %, or ≥14 wt % of component b and/or ≤30 wt %, or ≤27 wt %, or ≤25 wt %, or ≤22 wt %, or ≤20 wt %, or ≤18 wt %, or ≤16 wt % of component b, based on the weight of the composition.
O3] The composition of any one of E3]-N3] above, wherein the composition comprises ≥50 wt %, or ≥52 wt %, or ≥54 wt %, or ≥56 wt % of component a (first composition) and/or ≤100 wt %, or ≤98 wt %, or ≤96 wt %, or ≤94 wt %, or ≤92 wt %, or ≤91 wt %, or ≤90 wt % of component a, based on the weight of the composition.
P3] The composition of any one of E3]-03] above, wherein the weight ratio of component a to component b≥1.5, or ≥2.0, or ≥2.5, or ≥3.0, or ≥3.2, or ≥3.4, or ≥3.6, or ≥3.8, or ≥4.0 and/or ≤20, or ≤18, or ≤16, or ≤14, or ≤12, or ≤10, or ≤9.5, or ≤9.0 or ≤8.5, or ≤8.0, or ≤7.5, or ≤7.0.
Q3] The composition of any one of E3]-P3] above, wherein the composition comprises ≥50 wt %, or ≥52 wt %, or ≥55 wt %, or ≥57 wt %, or ≥60 wt %, or ≥62 wt %, or ≥64 wt %, or ≥66 wt %, or ≥68 wt %, or ≥69 wt %, or ≥70 wt %, or ≥71 wt %, or ≥72 wt % and/or ≤100 wt %, or ≤95 wt %, or ≤90 wt %, or ≤88 wt %, or ≤85 wt %, or ≤82 wt %, or ≤80 wt % of the sum of components a and b, based on the weight of the composition.
R3] The composition of any one of E3]-Q3] above, wherein the composition has a TMA value (heat resistance)≥116° C., or ≥117° C., or ≥118° C. and/or ≤125° C., or ≤124° C., or ≤123° C., or ≤122° C., or ≤121° C., or ≤120° C., or ≤119° C.
S3] The composition of any one of E3]-R3] above, wherein a plaque formed from the composition, as described herein, maintains a flat planar, slight curl or more curl configuration after thermal treatment in a ventilated oven at 116° C. for one week; and further, maintains a flat planar or slight curl configuration after thermal treatment in a ventilated oven at 116° C. for one week; and further maintains a flat planar configuration after thermal treatment in a ventilated oven at 116° C. for one week
T3] The composition of any one of A]-S3] above, wherein the composition further comprises a metal hydroxide (such as magnesium hydroxide) as component c.
U3] The composition of T3] above, wherein component c is a Mg(OH)₂.
V3] The composition of T3] or U3] above, wherein the composition comprises ≥10 wt %, or ≥12 wt %, or ≥14 wt %, or ≥16 wt %, or ≥18 wt %, or ≥20 wt %, or ≥22 wt %, or ≥24 wt % of component c and/or ≤40 wt %, or ≤38 wt %, or ≤36 wt %, or ≤34 wt %, or ≤32 wt %, or ≤30 wt %, or ≤28 wt %, or ≤26 wt % of component c, based on the weight of the composition.
W3] The composition of any one of A]-V3] above, wherein the composition further comprises at least one additive.
X3] The composition of W3] above, wherein the at least one additive is selected from fillers (for example, carbon black, calcium carbonate, talc and clay), flow aids, antioxidants, light stabilizers, pigments (for example, titanium dioxide), colorants, processing aids (for example, zinc stearate), oils or any combination thereof.
Y3] The composition of X3] above, wherein the at least one additive is selected from, antioxidants, light stabilizers, pigments (for example, titanium dioxide), colorants or any combination thereof.
Z3] The composition of any one of W3]-Y3] above, wherein the composition comprises at least two additives, or at least three additives.
A4] The composition of any one of W3]-Z3] above, wherein the at least one additive, or at least two additives or at least three additives, is/are present in an amount≥0.10 wt %, or ≥0.20 wt %, or ≥0.50 wt %, or ≥1.0 wt %, or ≥1.5 wt %, or ≥2.0 wt % and/or ≤10 wt %, or ≤8.0 wt %, or ≤6.0 wt %, or ≤4.0 wt %, or ≤3.5 wt %, or ≤3.2 wt %, based on the weight of the composition.
B4] The composition of any one of A]-A4] above, wherein the composition comprises ≤5.0 wt %, or ≤2.0 wt %, or ≤1.0 wt %, or ≤0.5 wt %, or ≤0.2 wt %, or ≤0.1 wt %, or ≤0.05 wt % of a propylene-based polymer, based on the weight of the composition; and further the composition does not comprise a propylene-based polymer.
C4] The composition of any one of T3]-B4] above, wherein the composition has a TMA value (heat resistance)≥116° C., or ≥117° C., or ≥118° C. and/or ≤125° C., or ≤124° C., or ≤123° C., or ≤122° C., or ≤121° C., or ≤120° C., or ≤119° C.
D4] The composition of any one of E3]-C4] above, wherein the composition has a MD Tensile Modulus≤200 MPa, or ≤190 MPa, or ≤180 MPa.
E4] The composition of any one of A]-D4] above, wherein the first composition comprises: ii) a melt index (I2) from 0.10 to 5.3 g/10 min.
F4] The composition of any one of A]-E4] above, wherein the second ethylene/alpha-olefin interpolymer has a peak iCCD temperature>80° C., or ≥82° C.
A5] An article comprising at least one component formed from the composition of any one of A]-F4] above.
B5] The article of A5] above, wherein the article is a roofing component, an automotive part, a footwear component, a window profile, a tire, a tube, a solar cell module or a cable.
C5] The article of B5] above, wherein the article is a roofing component.
D5] The article of B5] or C5] above, wherein the article is a TPO roofing membrane.
E5] A method of forming a TPO (thermoplastic polyolefin) composition, said method comprising mixing the composition of any one of A]-F4] above.
F5] A method of forming a TPO composition, said method comprising mixing the composition of any one of E3]-F4] above.
G5] A method of forming a TPO composition, said method comprising mixing the composition of any one of T3]-F4] above.
H5] The method of any one of E5]-G5] above, further comprising thermally treating the composition.

### Test Methods

### Melt Index

The melt index MI (or I2) of an ethylene-based polymer or composition is measured in accordance with ASTM D-1238, condition 190° C./2.16 kg. The melt index I10 of an ethylene-based polymer or composition is measured in accordance with ASTM D-1238, condition 190° C./10 kg. The melt flow rate MFR of a propylene-based polymer or composition is measured in accordance with ASTM D-1238, condition 230° C./2.16 kg.

### Density

A sheet of material is molded per ASTM D4703 Annex A.1 Procedure C (15° C. cooling). Each sample is first compression molded at 190° C., 3000 lbs for six minutes, then at 30000 lbs for four minutes, and then cooled at 15° C. per minute, until sample has cooled to 30° C. On removal from the press, three coupons (approx. 1.5″×approx. 0.5″×approx. 0.125″) are cut from the plaque. The density is measured within 1 hour of molding. Density is measured per D792 Method B using Isopropyl alcohol (IPA) as the immersion fluid. The coupons are weighed in air and then immersed in the IPA. The IPA is contained in a double walled vessel and the temperature is controlled to 23° C.+/−0.1° C. The samples are allowed to soak in the fluid for eight minutes to ensure the samples have equilibrated to the bath temperature. The samples are then weighed while still immersed in the fluid. A glass sinker of known dry weight and volume is then weighed, while immersed in the fluid. The density of the immersion fluid is calculated from the known and measured values for the glass sinker. The density of the samples may then be calculated from the known fluid density and the measured wet and dry sample weights. The results from the three coupons are averaged and the result reported in grams per cubic centimeter (g/cc=g/cm³).

### Differential Scanning Calorimetry (DSC)

In preparation for Differential Scanning calorimetry (DSC) testing, pellet-form samples are first loaded into a “1 inch diameter” chase of 0.13 mm thickness and compression molded into a film under 25,000 lbs of pressure, at 190° C., for approximately 10 seconds, with a Carver Hydraulic press. The resulting film is then cooled to room temperature. The film is then subjected to a punch press, in order to extract a disk that will fit the aluminum DSC test pan. The disk is then weighed individually (note: sample weight is approximately 4-8 mg), placed into the aluminum pan, and sealed, before being inserted into the DSC test chamber.

In reference to ASTM standard D3418, the DSC test is conducted using a heat-cool-heat cycle. First the sample is equilibrated at 230° C., and held isothermally for 5 minutes to remove thermal and process history. The sample is then quenched to −40° C. at a rate of 10° C./min, and held isothermally once again for 5 minutes, during the cooling cycle. Lastly, the sample is heated at a rate of 10° C./min to 230° C., for the second heating cycle. For data analysis, the melting temperatures and enthalpy of fusion are extracted from the second heating curve, whereas the enthalpy of crystallization is determined from the cooling curve. The enthalpy of fusion and crystallization are obtained by integrating the DSC thermogram from −20° C. to the end of melting and crystallization, respectively. The heat of fusion of 100% crystalline polyethylene is taken to be 292 J/g to calculate wt % crystallinity (for example, % cryst.=(Hf/292 J/g)×100 (for PE)). The DSC tests are performed using the TA Instruments Q2000 or Discovery DSCs, and data analyses are conducted via TA Instruments Universal Analysis and TRIOS software packages.

### Dynamic Mechanical Spectroscopy (DMS)

For preparation, each test sample was placed into a “9.75 inch by 10.25 inch” rectangular chase of thickness 1.85 mm, and compression molded at a pressure of 25,000 lbs for 6.5 minutes, at 190° C., with a Carver Hydraulic press. After cooling to room temperature, the resulting sample block was subjected to a “25 mm diameter” die cutter to extract a disk-shaped samples for rheological testing.

The DMS frequency sweep was conducted using “25 mm” parallel plates, at frequencies ranging from 0.1 to 100 rad/s. The test gap separating the plates was 1.8 mm, and a strain that satisfies linear viscoelastic conditions was utilized, typically 10% strain. Each test was conducted isothermally at 200° C. under nitrogen atmosphere. To initiate the DMS test, the rheometer oven was first allowed to equilibrate at the desired testing temperature for at least 30 minutes, before loading the sample into the test geometry. The sample was then equilibrated in the oven, with the door closed, for one minute. The test gap was then set to 1.8 mm, and the sample was allotted five minutes to relax the resulting normal force. Afterwards, the oven was quickly opened, and the sample was trimmed so that no bulge was present. The DMS measurement was then initiated after reclosing the oven. During the test, the shear elastic modulus (G′), viscous modulus (G″) and complex viscosity were measured. All DMS frequency tests were conducted on either ARES-G2 rheometer or DHR-3 rheometer, both of which were manufactured by TA Instruments. Data analyses were conducted via TA Instruments TRIOS software.

### TMA—Thermal Mechanical Analysis

Thermal Mechanical Analysis (Penetration Temperature) was conducted on “30 mm diameter×3.3 mm thick,” compression molded discs, formed at 180° C. and 10 MPa molding pressure, for five minutes, and then air quenched. The instrument was a “TMA 7” brand available from Perkin-Elmer. In the test, a probe, with “1.5 mm” radius tip (PIN N519-0416), was applied to the surface of the sample disc with 1 N force. The temperature was raised at rate of 5° C./min from 25° C. The probe penetration distance was measured as a function of temperature. The experiment ended when the probe had penetrated “1 mm” into the sample. One test sample was tested per composition, and the temperature at 1 mm penetration reported.

### C-Tear

Type C Tear was determined in accordance with ASTM D624. Test pieces were cut from a plaque or extruded sheet (see expt. Section) using a die conforming to the geometry specified in ASTM D624 for Type C test specimens. The specimens were conditioned for a minimum of 24 hours at 23 (+/−2° C.) and 50 (+/−10) % R.H. The sample thickness was measured at the center of the sample near the apex of the 90° indent. The specimen tabs were clamped in the grips of a tensile testing machine such that the long direction of the tabs was parallel to the direction of crosshead movement. The specimen was pulled at a crosshead rate of 20 (+/−2) inches/minute until completely ruptured. The maximum force during the test was recorded, and the tear strength calculated as the maximum force/sample thickness, in units of lbf/in (or kN/m). For blends in Table 8, the samples for C-tear test were die cut from “4 inch×6 inch×0.125 inch” injection molded plaques. For TPO compositions in Table 10, the samples for C-tear test were die cut from extruded sheets.

### Microtensile Modulus (MPa)—See First Compositions in Table 6.

A plaque (0.125 inch thickness) of material was molded as discussed in the description for the Density test method. Stress-strain behavior in uniaxial tension was measured using ASTM D1708 microtensile specimens. Specimens were die-cut from the plaques in conformation of the dimensions specified in ASTM D1708. The gauge length of samples was 22 mm, and samples were stretched with an INSTRON at 554% of (initial gauge length) min-1 at 23° C. Tensile properties were reported from an average of five specimens.

### Tensile Properties

Stress-strain behavior in uniaxial tension was measured using ASTM D1708 microtensile test samples. Specimens were die-cut from the “4 inch×6 inch×⅛ inch” plaques (PE blends with OBC in Table 8) or from the extruded sheets (TPO compositions in Table 10) in conformation of the dimensions specified in ASTM D1708. The gauge length of samples was 22 mm, and samples were stretched with an INSTRON at 554% of (initial gauge length) min-1 at 23° C. Tensile properties were reported from an average of 5 specimens.

### Flexural Modulus

Flexural and 1 or 2 percent secant moduli and chord moduli were measured according to ASTM D-790. Samples (PE blends with OBC in Table 8) were prepared by injection molding of ASTM Type I tensile bars (approx. 165 mm×19 mm×3 mm). A test speed of 0.05 in/min was chosen. Five test samples (per composition) were measured, and the average reported.

### Heat Resistance—Curl Analysis

Injection molded test samples (4 inch×6 inch×⅛ inch plaque) were laid flat on TEFLON fabric supported by steel plate in a ventilated oven, set at 116° C., for a week. After a week, the samples were removed from the oven and placed on countertop at ambient condition to cool. The flatness of the plaques was used as an indication for heat resistance. The curl height was defined as the maximum height of the corner or the edge of the “greatest degree of deformation” from a planar baseline (for example, a table). The curl height was reported in mm. One plaque per composition was tested. The degree of curl was categorized into 4 levels shown in the Table A below.

TABLE A
Curl Levels

| Level of Curl | Curl height (mm) |
|---|---|
| Flat | 0-4 |
| Slight Curl | 5-8 |
| More Curl | 9-14 |
| Severe Curl | ≥15 |

### Compositional Conventional GPC

The chromatographic system consisted of a PolymerChar GPC-IR (Valencia, Spain) high temperature GPC chromatograph equipped with an internal IR5 infra-red detector (IR5). The autosampler oven compartment was set at 160° Celsius and the column compartment was set at 150° Celsius. The columns were four Agilent “Mixed A,” 30 cm, 20-micron, linear mixed-bed columns. The chromatographic solvent was 1,2,4 trichlorobenzene, which contained 200 ppm of butylated hydroxytoluene (BHT). The solvent source was nitrogen sparged. The injection volume was 200 microliters and the flow rate was 1.0 milliliter/minute.

Calibration of the GPC column set was performed with 21 narrow molecular weight distribution polystyrene standards, with molecular weights ranging from 580 to 8,400,000 g/mol, and arranged in six “cocktail” mixtures, with at least a decade of separation between individual molecular weights. The standards were purchased from Agilent Technologies. The polystyrene standards were prepared at “0.025 grams in 50 milliliters of solvent” for molecular weights equal to, or greater than, 1,000,000, and “0.05 grams in 50 milliliters of solvent” for molecular weights less than 1,000,000. The polystyrene standards were pre-dissolved at 80° C., with gentle agitation, for 30 minutes, and then cooled. The room temperature solution was transferred, cooled, into the autosampler dissolution oven, at 160° C., for 30 minutes. The polystyrene standard peak molecular weights were converted to polyethylene molecular weights using Equation 1 (as described in Williams and Ward, J. Polym. Sci., Polym. Let., 6, 621 (1968)).:

M_{polyethylene}=A×(M_{polystyrene})^{B} (EQ1), where M is the molecular weight,

A has a value of 0.405 and B is equal to 1.0. A fifth order polynomial was used to fit the respective polyethylene-equivalent calibration points.

The total plate count of the GPC column set was performed with decane, which was introduced into a blank sample via a micropump, controlled with the PolymerChar GPC-IR system. The plate count for the chromatographic system should be greater than 18,000 for the four Agilent “Mixed A,” 30 cm, 20-micron, linear mixed-bed columns.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for two hours at 160° Celsius under “low speed” shaking.

The calculations of Mn (GPC), MW (GPC), and MZ (GPC) were based on GPC results using the internal IR5 detector (measurement channel) of the PolymerChar GPC-IR chromatograph according to Equations 2-4, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1.

$${Mn}_{( GPC )} = \frac{{\sum }^{i} {IR}_{i}}{{\sum }^{i} ( {IR}_{i} / {M}_{{polyethylene}_{i}} )} ; \qquad ( EQ . 2 )$$

$${Mw}_{( GPC )} = \frac{{\sum }^{i} ( {IR}_{i} / {M}_{{polyethylene}_{i}} )}{{\sum }^{i} {IR}_{i}} ; \qquad ( EQ . 3 )$$

$${Mz}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} . \qquad ( EQ . 4 )$$

In order to monitor the deviations over time, a flowrate marker (decane) was introduced into each sample via a micropump controlled with the PolymerChar GPC-IR system. This flowrate marker (FM) was used to linearly correct the pump flowrate (Flowrate (nominal)) for each sample by RV alignment of the respective decane peak within the sample (RV(FM Sample)) to that of the decane peak within the narrow standards calibration (RV(FM Calibrated)). Any changes in the time of the decane marker peak were then assumed to be related to a linear-shift in flowrate (Flowrate (effective)) for the entire run. After calibrating the system based on a flow marker peak, the effective flowrate (with respect to the narrow standards calibration) was calculated as Equation 5. Processing of the flow marker peak was done via the PolymerChar GPCOne™ Software. Acceptable flowrate correction is such that the effective flowrate should be within +/−0.5% of the nominal flowrate.

$$Flowrate ( effective ) = Flowrate ( nominal ) * ( RV ( FM Calibrated ) / RV ( FM sample ) ) . \qquad ( EQ 5 )$$

### IR5 GPC Octene Composition Calibration

A calibration for the IR5 detector rationing was performed using at least ten ethylene-based polymer standards (octene as comonomer) made by single-site metallocene catalyst from a single reactor in solution process (polyethylene homopolymer and ethylene/octene copolymers), and of a narrow SCB distribution and known comonomer content (as measured by ¹³C NMR Method, Qiu et al., Anal. Chem. 2009, 81, 8585-8589). These standards ranged from homopolymer (0 SCB/1000 total C) to approximately 40 SCB/1000 total C, where total C=carbons in backbone+carbons in branches. Each standard had a weight-average molecular weight from 36,000 g/mole to 126,000 g/mole measured by GPC. Each standard had a molecular weight distribution (Mw/Mn) from 2.0 to 2.5. Polymer properties for the SCB standards are shown in Table B.

TABLE B
“Copolymer” Standards

| Wt % Comonomer | IR5 Area ratio | SCB/1000 Total C | Mw | Mw/Mn |
|---|---|---|---|---|
| 23.1 | 0.2411 | 28.9 | 37,300 | 2.22 |
| 14.0 | 0.2152 | 17.5 | 36,000 | 2.19 |
| 0.0 | 0.1809 | 0.0 | 38,400 | 2.20 |
| 35.9 | 0.2708 | 44.9 | 42,200 | 2.18 |
| 5.4 | 0.1959 | 6.8 | 37,400 | 2.16 |
| 8.6 | 0.2043 | 10.8 | 36,800 | 2.20 |
| 39.2 | 0.2770 | 49.0 | 125,600 | 2.22 |
| 1.1 | 0.1810 | 1.4 | 107,000 | 2.09 |
| 14.3 | 0.2161 | 17.9 | 103,600 | 2.20 |
| 9.4 | 0.2031 | 11.8 | 103,200 | 2.26 |

The “IR5 Area Ratio (or “IR5 Methyl Channel Area/IR5 Measurement Channel Area”)” of “the baseline-subtracted area response of the IR5 methyl channel sensor” to “the baseline-subtracted area response of IR5 measurement channel sensor” (standard filters and filter wheel as supplied by PolymerChar: Part Number IR5_FWM01 included as part of the GPC-IR instrument) was calculated for each of the “SCB” standards. A linear fit of the SCB frequency versus the “IR5 Area Ratio” was constructed in the form of the following Equation 6: SCB/1000 total C=A0+ [A1×(IR5_{Methyl Channel Area}/IR5_{Measurement Channel Area})] (EQ 6), where A₀ is the “SCB/1000 total C” intercept at an “IR5 Area Ratio” of zero, and A₁ is the slope of the “SCB/1000 total C” versus “IR5 Area Ratio” and represents the increase in the SCB/1000 total C as a function of “IR5 Area Ratio.” The IR5 area ratio is equal to the IR5 height ratio for narrow PDI and narrow SCBD standard materials. This method can be adapted for other alpha-olefins.

### GPC MWCDI Calculation

A series of linear baseline-subtracted chromatographic heights” for the chromatogram generated by the “IR5 methyl channel sensor” was established as a function of column elution volume, to generate a baseline-corrected chromatogram (methyl channel). “A series of linear baseline-subtracted chromatographic heights” for the chromatogram generated by the “IR5 measurement channel” was established as a function of column elution volume, to generate a base-line-corrected chromatogram (measurement channel).

The “IR5 Height Ratio” of “the baseline-corrected chromatogram (methyl channel)” to “the baseline-corrected chromatogram (measurement channel)” was calculated at each column elution volume index (each equally-spaced index, representing one data point per second at one ml/min elution flow rate) across the sample integration bounds. The “IR5 Height Ratio” was multiplied by the coefficient A1, and the coefficient A₀ was added to this result, to produce the predicted SCB frequency of the sample. The result was converted into mole percent comonomer as follows in Equation 7:

$$Mol \% Comonomer = \{ {SCB}_{f} / [ {SCB}_{f} + ( ( 1 \; 000 - {SCB}_{f} * Length of comonomer ) / 2 ) ] \} * 100$$

(EQ 7), where “SCBf” is the “SCB per 1000 total C”, and the “Length of comonomer”=8 for octene. Note A1 and A₀ are defined above.

The comonomer composition, reported as octene comonomer, and molecular weight from a molecular weight value (Mwᵢ) using the method of Williams and Ward (described above; EQ. 1), were obtained at each chromatographic slice i, taken as a data point per second as described above. The “Mole Percent Comonomer (y axis)” was plotted as a function of Log(Mwᵢ), and the slope was calculated between Mwᵢ of 15,000 and Mwᵢ of 150,000 g/mole (end group corrections on chain ends were omitted for this calculation). An EXCEL linear regression was used to calculate the slope between, and including, Mwᵢ from 15,000 to 150,000 g/mole. This slope is defined as the molecular weighted comonomer distribution index (MWCDI=Molecular Weighted Comonomer Distribution Index). An example profile is shown in FIG. 1.

### Deconvolution of GPC Chromatogram

The fitting of the GPC chromatogram into a high molecular weight (HMW) component fraction and a low molecular weight (LMW) component fraction was accomplished using a Flory distribution, which was broadened with a normal distribution function as follows: for the log M axis, 601 equally-spaced Log(M) points, spaced by 0.01, were established between 2 and 8 representing the molecular weight range between 100 and 100,000,000, where Log is the logarithm function to the base 10. At any given Log(M), the population of the Flory distribution was in the form of Equation 8:

$${dW}_{f} / dLogM = {( \frac{2}{{M}_{w}} )}^{3} ( \frac{{M}_{w}}{0.868588961964} ) {M}^{2} {e}^{( - 2 M / {M}_{w} )} , \qquad ( EQ . 8 )$$

where Mw is the weight-average molecular weight of the Flory distribution and M is the specific x-axis absolute molecular weight point, (10\hat{ }[Log(M)]). The Flory distribution weight fraction was broadened at each “0.01 equally-spaced log (M) index” according to a normal distribution function, of width expressed in Log(M), σ (described as s below); peak center u (described below as Mw1 and Mw2 for each component), and current M index expressed as Log(M), σ. See Equation 9.

$${f}_{( LogM , μ , σ )} = {e}^{- \frac{{( LogM - μ )}^{2}}{2 {σ}^{2}}} . \qquad ( EQ . 9 )$$

It should be noted that before and after the spreading function has been applied, that the area of the distribution (dW_{f}/d Log M), as a function of Log(M), is normalized to unity. Two weight-fraction distributions, dW_{f1} and dW_{f2}, for LMW and HMW components, or components 1 and 2, were expressed with two unique Mw target values, Mw1 and Mw2, and with overall component compositions A₁ and A₂, where each composition weight % is determined by the reactor process. Both distributions were broadened with the same width, s. The two distributions were summed as follows in Equation 10:

$${dW}_{f} / dLogM = {A}_{1} {dW}_{f 1} / dLogM + {A}_{2} {dW}_{f 2} / dLogM \qquad ( EQ . 10 )$$

$$where : {A}_{1} + {A}_{2} = 1 .$$

The weight fraction result of the measured absolute GPC molecular weight distribution was interpolated along 601 log M points using a 2^{nd} order polynomial. Microsoft Excel™ 2010 Solver was used to minimize the sum of squares of residuals for the equally-spaces range of 601 Log M points between the interpolated chromatographically determined molecular weight distribution and the two broadened Flory distribution components (s₁ and s₂), weighted with their respective component compositions, A1 and A2. The iteration starting values for the components are as follows:

$$Component 1 : {Mw}_{1} = 20 , 000 , s = 0.2 \; 00 , and$$

$${A}_{1} = 0.35 ( Designs A - D ) and 0.51 ( Design E ) ;$$

$$Component 2 : {Mw}_{2} = 150 , 000 , s = 0.2 \; 00 , and {A}_{2} = 1 - {A}_{1} .$$

$$( Note s 1 = s 2 and {A}_{1} + {A}_{2} = 1 ) .$$

The bounds for components 1 and 2 are such that s is constrained, such that s>0.001, yielding an Mw/Mn of approximately 2.00, and s<0.550, yielding a Mw/Mn of approximately 5.71. The composition, A1, is constrained between 0.000 and 1.000. The Mw1 is constrained between 2,500 and 2,000,000. The composition, A2, is constrained between 0.000 and 1.000. The Mw2 is constrained between 2,500 and 2,000,000. The “GRG Nonlinear” engine was selected in Excel Solver™ and precision was set at 0.00001 and convergence was set at 0.0001. The solutions were obtained after convergence (in all cases shown, the solution converged within 60 iterations).

Method for Comonomer Content Analysis (iCCD)

Improved method for comonomer content analysis (iCCD) was developed in 2015 (Cong and Parrott et al., WO2017040127A1). The iCCD test was performed with Crystallization Elution Fractionation instrumentation (CEF) (PolymerChar, Spain) equipped with IR-5 detector (PolymerChar, Spain) and two angle light scattering detector Model 2040 (Precision Detectors, currently Agilent Technologies). Ortho-dichlorobenzene (ODCB, 99% anhydrous grade or distilled) was used. Silica gel 40 (particle size 0.2~0.5 mm, catalogue number 10181-3) from EMD Chemicals was obtained (can be used to dry ODCB solvent before use). The CEF instrument was equipped with an autosampler with N2 purging capability. The ODCB was sparged with dried nitrogen (N2) for one hour before use. Sample preparation was done with the autosampler at 4 mg/ml (unless otherwise specified), under shaking at 160° C. for one hour. The injection volume was 300 μl. The temperature profile of iCCD was as follows: crystallization at 3° C./min from 105° C. to 30° C., thermal equilibrium at 30° C. for 2 minute (including Soluble Fraction Elution Time being set as 2 minutes), elution at 3° C./min from 30° C. to 140° C. The flow rate during crystallization is 0.0 ml/min. The flow rate during elution is 0.50 ml/min. The data was collected at one data point/second.

The iCCD column was packed with gold coated nickel particles (Bright 7GNM8-NiS, Nippon Chemical Industrial Co.) in a 15 cm (length)×¼″ (ID) stainless tubing. The column packing and conditioning used a slurry method according to the reference (Cong, R.; Parrott, A.; Hollis, C.; Cheatham, M. WO2017040127A1). The final pressure with TCB slurry packing was 150 Bars.

Column temperature calibration was performed by using a mixture of the Reference Material Linear homopolymer polyethylene (having zero comonomer content, Melt index (I₂) of 1.0, polydispersity M_{w}/Mₙ approximately 2.6 by conventional gel permeation chromatography, 1.0 mg/ml) and EICOSANE (2 mg/ml) in ODCB. The iCCD temperature calibration consisted of four steps: (1) Calculating the delay volume defined as the temperature offset between the measured peak elution temperature of EICOSANE minus 30.00° C.; (2) Subtracting the temperature offset of the elution temperature from iCCD raw temperature data—is noted that this temperature offset is a function of experimental conditions, such as elution temperature, elution flow rate, etc.; (3) Creating a linear calibration line transforming the elution temperature across a range of 30.00° C. and 140.00° C., so that the linear homopolymer polyethylene reference had a peak temperature at 101.0° C., and EICOSANE had a peak temperature of 30.0° C.; (4) For the soluble fraction measured isothermally at 30° C., extrapolating linearly the elution temperature below 30.0° C. by using the elution heating rate of 3° C./min, according to the reference (Cerk and Cong et al., U.S. Pat. No. 9,688,795).

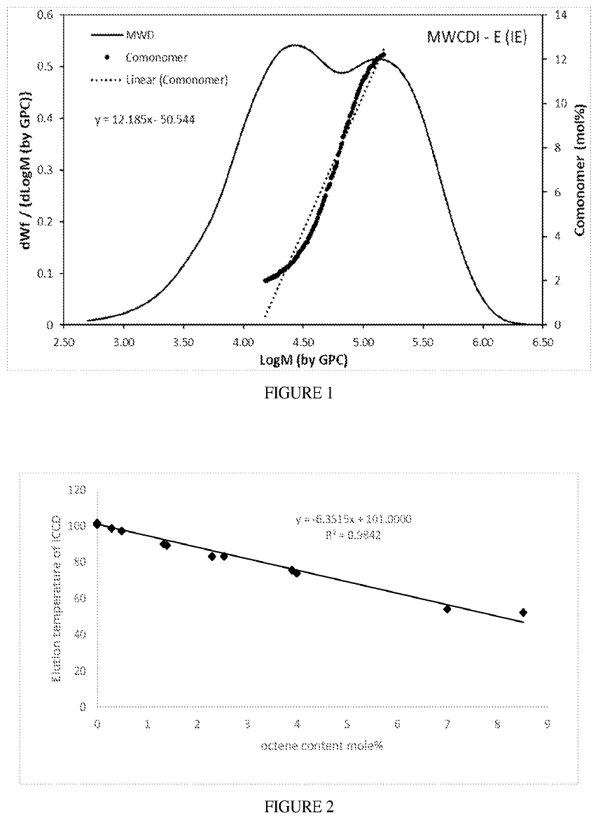

The comonomer content versus elution temperature of iCCD was constructed by using 12 reference materials (ethylene homopolymer and ethylene-octene random copolymer made with single site metallocene catalyst, having ethylene equivalent weight average molecular weight ranging from 35,000 to 128,000). All of these reference materials were analyzed the same way as specified previously at 4 mg/mL. The reported elution peak temperatures followed the figure of octene mole % versus elution temperature of iCCD at R2 of 0.984. This relationship is shown in FIG. 2. This method can be adapted for other alpha-olefins.

### EXPERIMENTAL

Commercial reagents and polymers are shown in Table 1.

TABLE 1
Commercial Reagents and Polymers

| Reagent or Polymer | Description | Source |
|---|---|---|
| IRGANOX B225 | Antioxidant, | BASF |
| | 50% IRGAFOS 168 and 50% IRGANOX 1010 | |
| CHIMASSORB 2020 | High molecular weight, hindered amine, light stabilizer | BASF |
| Mg(OH)₂ MAGNIFIN H-5 | Magnesium Hydroxide, Flame retardant | Huber |
| TiO₂ Ti-Pure R960 | Titanium dioxide, White pigment | Chemours |
| INFUSE 9107 Olefin Block Copolymer | Ethylene/alpha-olefin multi-block copolymer, | DOW* |
| | density of 0.866 g/cc, 12 of 1.0 g/10 min | |
| INFUSE 9010 Olefin Block Copolymer | Ethylene/alpha-olefin multi-block copolymer, | DOW |
| | density of 0.877 g/cc, 12 of 0.50 g/10 min | |
| DOWLEX 2036G Polyethylene Resin | Linear Low Density Polyethylene | DOW |
| HIFAX CA10A | Thermoplastic Polyolefin (TPO) | LyondellBasell |

*The Dow Chemical Company

### First Compositions, Characterizations and Syntheses

First compositions are shown in Table 2A. Each property listed in Table 2A represents a target property. Each first composition A-E is an in-reactor blend. Here, “Rx1” refers to the first reactor, and “Rx2” refers to the second reactor.

TABLE 2A
First Compositions (Target Properties)

| | | | | | | 12 Rx2 | Overall | Overall | |
|---|---|---|---|---|---|---|---|---|---|
| First | Density Rx1 | Density Rx2 | | | I2 Rx1 | (increase | I2 | Density | D2-D1 |
| comp.* | (D1) g/cc | (D2) g/cc | Rx1 (%) | Rx2 (%) | g/10 min | in 12) | g/10 min | g/cc | g/cc |
| A (IE) | 0.878 | 0.950 | 65 | 35 | 0.225 | Wide split | 0.85 | 0.902 | 0.072 |
| B (CE) | 0.883 | 0.945 | 65 | 35 | 0.225 | Wide split | 0.85 | 0.902 | 0.062 |
| C (IE) | 0.883 | 0.945 | 65 | 35 | 0.23 | Wide split | 0.85 | 0.902 | 0.062 |
| D (CE) | 0.883 | 0.945 | 65 | 35 | 1.18 | Wide split | 3.0 | 0.902 | 0.062 |
| E (IE) | 0.870 | 0.935 | 49 | 51 | 0.15 | Wide split | 0.85 | 0.902 | 0.065 |
| F (IE) | 0.863 | 0.937 | 50 | 50 | 0.045 | Wide split | 0.30 | 0.899 | 0.074 |
| G (IE) | 0.860 | 0.935 | 60 | 40 | 0.053 | Wide split | 0.30 | 0.888 | 0.075 |

*Each first composition contains two ethylene/octene copolymers-one copolymer is produced in each reactor.

### Syntheses

All raw materials (monomer and comonomer) and the process solvent (a narrow boiling range high-purity isoparaffinic solvent, ISOPAR-E) are purified with molecular sieves before introduction into the reaction environment. Hydrogen is supplied pressurized as a high purity grade and is not further purified. The reactor monomer feed stream is pressurized via a mechanical compressor to above reaction pressure. The solvent and comonomer feed is pressurized via a pump to above reaction pressure. The individual catalyst components are manually batch diluted with purified solvent and pressured to above reaction pressure. All reaction feed flows are measured with mass flow meters and independently controlled with computer automated valve control systems.

A two-reactor system is used in a series configuration. The first continuous solution polymerization reactor consists of a liquid full, non-adiabatic, isothermal, circulating, loop reactor which mimics a continuously stirred tank reactor (CSTR) with heat removal. Independent control of all fresh solvent, monomer, comonomer, hydrogen, and catalyst component feeds is possible. The total fresh feed stream to the first reactor (solvent, monomer, comonomer, and hydrogen) is temperature controlled to maintain a single solution phase by passing the feed stream through a heat exchanger. The total fresh feed to each polymerization reactor is injected into the reactor at three locations with approximately equal reactor volumes between each injection location. The fresh feed is controlled with each injector receiving one third of the total fresh feed mass flow. The catalyst components are injected into the polymerization reactor at two different locations with similar reactor volumes between each injection location. The primary catalyst component feed is computer controlled to maintain the reactor monomer conversion at the specified target. The cocatalyst components are fed based on either specified molar ratios to the primary catalyst component or to target a specified concentration in the reactor. Immediately following each reactor feed or catalyst injection location, the streams are mixed with the circulating polymerization reactor contents with static mixing elements. The contents of the reactor are continuously circulated through heat exchangers responsible for removing much of the heat of reaction and with the temperature of the coolant side responsible for maintaining an isothermal reaction environment at the specified temperature. Circulation around each reactor loop is provided by a pump.

The second continuous solution polymerization reactor consists of a liquid full, non-adiabatic, isothermal, circulating, loop reactor which mimics a continuously stirred tank reactor (CSTR) with heat removal. Independent control of all fresh solvent, monomer, comonomer, hydrogen, and catalyst component feeds is possible. The total fresh feed stream to the second reactor (solvent, monomer, comonomer, and hydrogen) is temperature controlled to maintain a single solution phase by passing the feed stream through a heat exchanger. The total fresh feed to each polymerization reactor is injected into the reactor at two locations with approximately equal reactor volumes between each injection location. The fresh feed is controlled with each injector receiving half of the total fresh feed mass flow. The catalyst components are injected into the polymerization reactor through injection stingers. The primary catalyst component feed is computer controlled to maintain the reactor monomer conversion at the specified target. The cocatalyst components are fed either based on calculated specified molar ratios to the primary catalyst component or to target a specified concentration in the reactor. Immediately following each reactor feed injection location, the streams are mixed with the circulating polymerization reactor contents with static mixing elements. The contents of each reactor are continuously circulated through heat exchangers responsible for removing much of the heat of reaction and with the temperature of the coolant side responsible for maintaining an isothermal reaction environment at the specified temperature. Circulation around each reactor loop is provided by a pump.

The effluent from the first polymerization reactor (containing solvent, monomer, comonomer, hydrogen, catalyst components, and polymer) exits the first reactor and is added to the second reactor.

The final reactor effluent enters a zone where it is deactivated with the addition of, and reaction with, a suitable reagent (water). At this same reactor exit location, other additives are added for polymer neutralization (calcium stearate) if they are needed when using acid generating catalyst species. Additional additive stabilization (typical antioxidants suitable for stabilization include, but are not limited to, octadecyl-3,5-di-tert-butyl-4-hydroxyhydrocinnamate, tetrakis(methylene (3,5-di-tert-butyl-4-hydroxyhydrocinnamate)) methane, and tris(2,4-di-tert-butyl-phenyl) phosphite).

Following catalyst deactivation and additive addition, the reactor effluent enters a devolatization system, where the polymer is removed from the non-polymer stream. The isolated polymer melt is pelletized and collected. The non-polymer stream passes through various pieces of equipment, which separate most of the ethylene that is removed from the system. Most of the solvent and unreacted comonomer is recycled back to the reactor after passing through a purification system. A small amount of solvent and comonomer is purged from the process. The reactor stream feed data flows that correspond to the values in Table 2C, used to produce the examples, are graphically described in Schematic A. Catalysts and co-catalysts are shown in Table 2B. The data are presented, such that the solvent recycle system is accounted for and the reaction system can be treated more simply as a once through flow diagram.

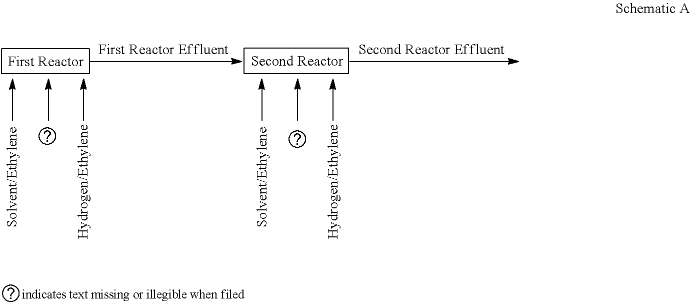

TABLE 2B
Catalysts and Co-catalysts

| | |
|---|---|
| Catalyst A | 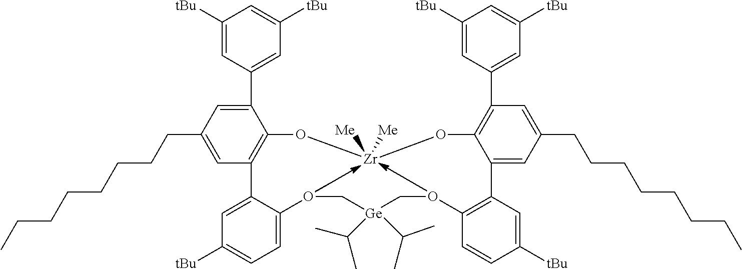 |
| | WO2018/183056 |
| Catalyst B | 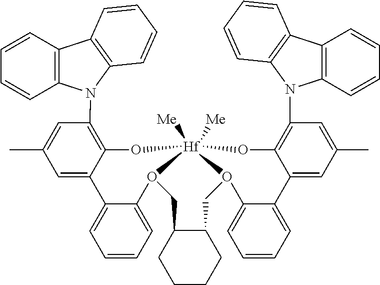 |
| | U.S. 2004/0010103 |
| Catalyst C | The heterogeneous Ziegler-Natta type catalyst-premix was prepared substantially according |
| | to U.S. Pat. No. 4,612,300, by sequentially adding to a volume of ISOPAR E, a slurry of |
| | anhydrous magnesium chloride in ISOPAR E, a solution of EtAlCl₂ in heptane, and a |
| | solution of Ti(O—iPr)₄ in heptane, to yield a composition containing a magnesium |
| | concentration of 0.20M and a ratio of Mg/Al/Ti of 40/12.5/3. |
| | While being fed to, and prior to entry into the polymerization reactor, the catalyst premix |
| | was contacted with a dilute solution of Et3Al, in the molar Al to Ti ratio specified in Table |
| | 2B, to give the active catalyst. |
| Catalyst D | 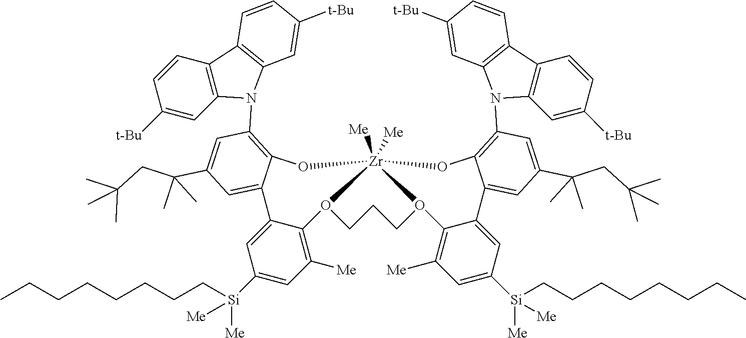 |
| | WO2021/091994 |
| Catalyst E | 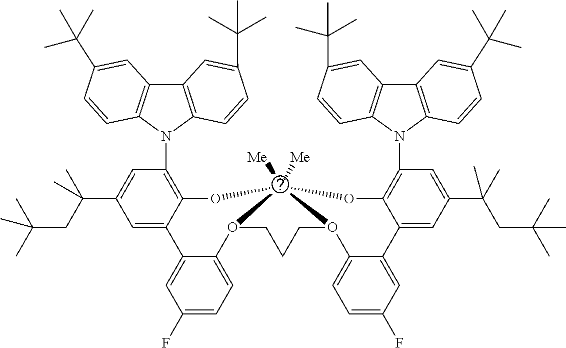 |
| Co-Cat A | R [symbol] MeNH⁺ (R = hydrogenated tallow alkyl) |
| | 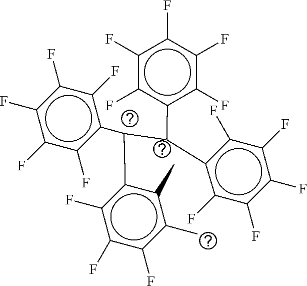 |
| Co-Cat B | Modified methyl aluminoxane |
| Co-Cat C | Triethyl aluminum |

[symbol]

indicates data missing or illegible when filed

TABLE 2C
Reactor Data

| | | A (IE) | B (CE) | C (IE) | D (CE) | E (IE) | F (IE) | G (IE) |
|---|---|---|---|---|---|---|---|---|
| | | Dual | Dual | Dual | Dual | Dual | Dual | Dual |
| Reactor Configuration | Type | Series | Series | Series | Series | Series | Series | Series |
| Comonomer type | Type | 1-octene | 1-octene | 1-octene | 1-octene | 1-octene | 1-octene | 1-octene |
| First Reactor Feed Solvent/ | g/g | 6.84 | 5.46 | 5.90 | 5.04 | 7.66 | 9.11 | 8.40 |
| Ethylene Mass Flow Ratio | | | | | | | | |
| First Reactor Feed Comonomer/ | g/g | 0.781 | 1.13 | 0.631 | 0.641 | 0.992 | 1.34 | 1.63 |
| Ethylene Mass Flow Ratio | | | | | | | | |
| First Reactor Feed Hydrogen/ | g/g | 3.38E−05 | 1.04E−04 | 1.91E−04 | 2.91E−04 | 9.02E−05 | 4.50E−05 | 5.86E−05 |
| Ethylene Mass Flow Ratio | | | | | | | | |
| First Reactor Temperature | ° C. | 160 | 160 | 160 | 160 | 160 | 162 | 163 |
| First Reactor Pressure | barg | 50 | 50 | 50 | 50 | 50 | 40 | 40 |
| First Reactor Ethylene Conversion | % | 93.1 | 82.9 | 91.9 | 92.4 | 90.1 | 84.0 | 80.7 |
| First Reactor Catalyst Type | Type | Catalyst | Catalyst | Catalyst | Catalyst | Catalyst | Catalyst | Catalyst |
| | | A | A | B | B | B | E | E |
| First Reactor Catalyst Metal | Type | Zr | Zr | Hf | Hf | Hf | Hf | Hf |
| First Reactor Co-Catalyst 1 Type | Type | Co-Cat A | Co-Cat A | Co-Cat | Co-Cat | Co-Cat | Co-Cat | Co-Cat |
| | | | | A | A | A | A | A |
| First Reactor Co-Catalyst 2 Type | Type | Co-Cat B | Co-Cat B | Co-Cat | Co-Cat | Co-Cat | Co-Cat | Co-Cat B |
| | | | | B | B | B | B | |
| First Reactor Co-Catalyst 1 to | mol/mol | 1.5 | 1.5 | 1.2 | 1.2 | 1.2 | 1.2 | 1.2 |
| Catalyst Molar Ratio (B to | | | | | | | | |
| Catalyst Metal ratio) | | | | | | | | |
| First Reactor Co-Catalyst 2 Al | ppm | 2.0 | 2.0 | 2.0 | 2.0 | 2.0 | 0.12 | 0.16 |
| concentration | | | | | | | | |
| First Reactor Residence Time | min | 12.9 | 12.4 | 14.1 | 16.3 | 17.5 | 38.1 | 33.1 |
| Percentage of Total Ethylene Feed | wt % | 56.9% | 65.9% | 58.7% | 58.2% | 41.0% | 40.4% | 54.3% |
| to First Reactor | | | | | | | | |
| Second Reactor Feed Solvent/ | g/g | 2.44 | 2.27 | 2.47 | 2.46 | 2.49 | 3.87 | 4.57 |
| Ethylene Mass Flow Ratio | | | | | | | | |
| Second Reactor Feed Comonomer/ | g/g | 0.125 | 0.309 | 0.0890 | 0.103 | 0.114 | 0.56 | 0.87 |
| Ethylene Mass Flow Ratio | | | | | | | | |
| Second Reactor Feed Hydrogen/ | g/g | 1.08E−03 | 1.41E−03 | 1.41E−03 | 1.41E−03 | 9.14E−04 | 1.66E−04 | 2.70E−04 |
| Ethylene Mass Flow Ratio | | | | | | | | |
| Second Reactor Temperature | ° C. | 205 | 205 | 195 | 195 | 195 | 195 | 195 |
| Second Reactor Pressure | barg | 50 | 50 | 50 | 50 | 50 | 40 | 40 |
| Second Reactor Ethylene | % | 84.9 | 80.4 | 85.6 | 84.7 | 88.5 | 86.1 | 85.3 |
| Conversion | | | | | | | | |
| Second Reactor Catalyst Type | Type | Catalyst | Catalyst | Catalyst | Catalyst | Catalyst | Catalyst | Catalyst |
| | | D | D | C | C | C | D | D |
| Second Reactor Catalyst Metal | Type | Zr | Zr | Ti | Ti | Ti | Zr | Zr |
| Second Reactor Co-Catalyst 1 | Type | Co-Cat A | Co-Cat A | — | — | — | Co-Cat | Co-Cat |
| Type | | | | | | | A | A |
| Second Reactor Co-Catalyst 2 | Type | Co-Cat B | Co-Cat B | Co-Cat | Co-Cat | Co-Cat | Co-Cat | Co-Cat B |
| Type | | | | C | C | C | B | |
| Second Reactor Co-Catalyst 1 to | mol/mol | 15.0 | 15.0 | — | — | — | 38 | 20 |
| Catalyst Molar Ratio (B to | | | | | | | | |
| Catalyst Metal ratio) | | | | | | | | |
| Second Reactor Co-Catalyst 2 to | mol/mol | — | — | 4.0 | 4.0 | 4.0 | — | — |
| Catalyst Molar Ratio (Al to Ti | | | | | | | | |
| ratio) | | | | | | | | |
| Second Reactor Co-Catalyst 2 Al | ppm | 0.25 | 0.25 | — | — | — | 0.5 | 0.5 |
| concentration | | | | | | | | |
| Second Reactor Residence Time | min | 5.2 | 5.3 | 5.6 | 6.3 | 6.1 | 29.7 | 29.7 |

### ADDITIONAL CHARACTERIZATIONS

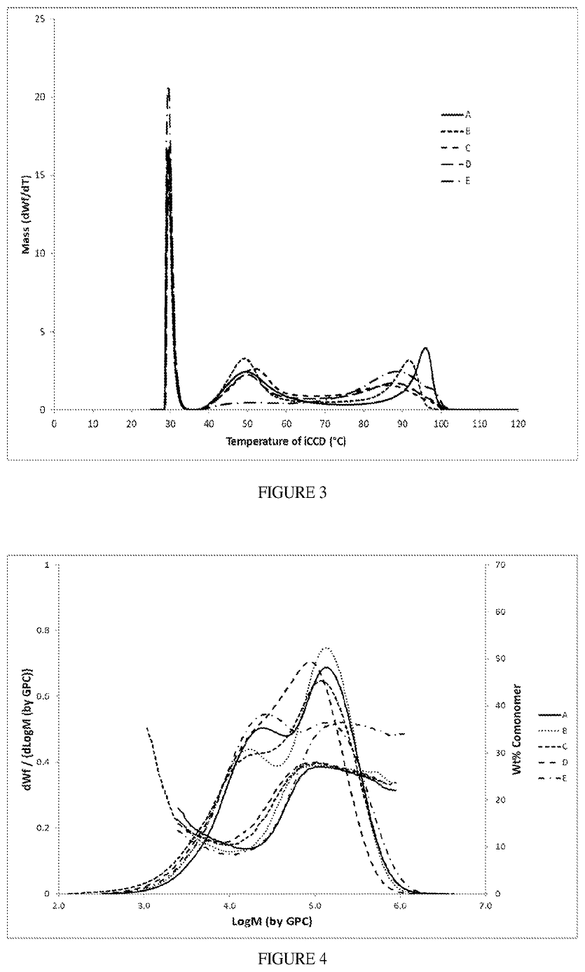

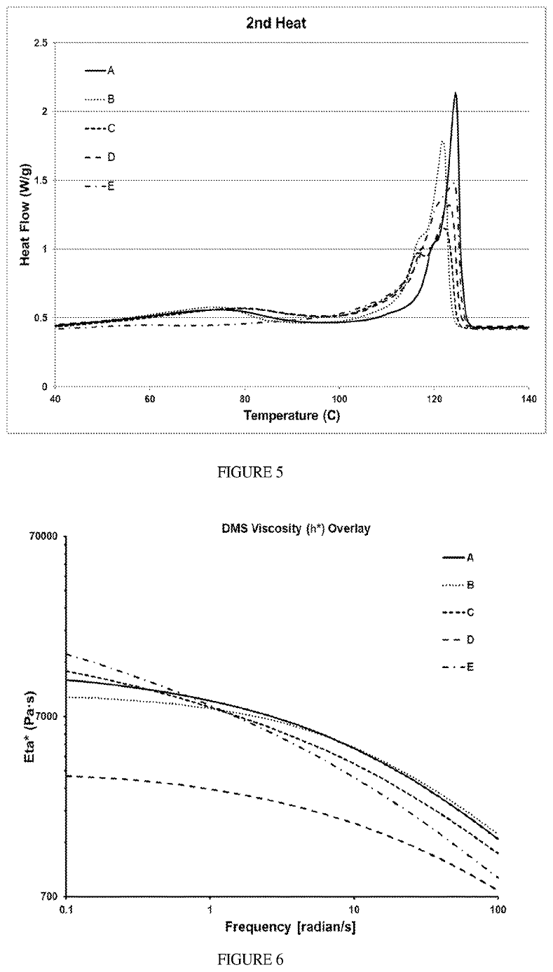

The results from a GPC (conventional) analysis on the first compositions, and the corresponding deconvolutions, are shown in Tables 3 and 4, respectively. The iCCD profiles are shown in FIG. 3, and “GPC MWD profiles and corresponding comonomer distribution overlays” are shown in FIG. 4. For the deconvolution results, the ethylene/octene copolymer made in the first reactor is denoted using the number “1” and the ethylene/octene copolymer made in the second reactor is denoted using the number “2”. DSC profiles and DMS profiles are shown in FIGS. 5 and 6, respectively. DSC and Rheology features are shown in Table 5, and additional properties are shown in Table 6. Each property shown in Tables 3-6 represent, or derive from, an actual measurement on a first composition.

TABLE 3
First Compositions-GPC Results (Mn, Mw and Mz in g/mol)

| First Comp. | Mn | Mw | Mz | MWD | Mz/Mw | MWCDI |
|---|---|---|---|---|---|---|
| A (IE) | 20139 | 118240 | 313426 | 5.87 | 2.65 | 8.23 |
| B (CE) | 17671 | 114766 | 274695 | 6.49 | 2.39 | 8.01 |
| C (IE) | 14501 | 111658 | 305097 | 7.70 | 2.73 | 6.96 |
| D (CE) | 15357 | 83309 | 210204 | 5.43 | 2.52 | 4.06 |
| E (IE) | 16461 | 122977 | 382089 | 7.47 | 3.11 | 12.19 |
| F (IE) | 39870 | 186182 | 512373 | 4.67 | 2.75 | 7.40 |
| G (IE) | 28921 | 174827 | 449328 | 6.04 | 2.57 | 15.3 |

The notation “CE” refers to a comparative first composition, and “IE” to an inventive first composition.

TABLE 4
First Compositions-Deconvolution of GPC Profiles (Mn, Mw and Mz in g/mol)

| | LMW | | | HMW | | | Ratios | | |
|---|---|---|---|---|---|---|---|---|---|
| | Mw2 | Mn2 | MWD2 | Mw1 | Mn1 | MWD1 | Mw1/Mw2 | Mn1/Mn2 | MWD1/MWD2 |
| A (IE) | 19122 | 8812 | 2.17 | 170698 | 69109 | 2.47 | 8.93 | 7.84 | 1.14 |
| B (CE) | 16196 | 6981 | 2.32 | 163199 | 72857 | 2.24 | 10.08 | 10.45 | 0.97 |
| C (IE) | 16925 | 6066 | 2.79 | 166209 | 60882 | 2.73 | 9.82 | 10.04 | 0.98 |
| D (CE) | 18919 | 6685 | 2.83 | 118731 | 46199 | 2.57 | 6.28 | 6.91 | 0.91 |
| E (IE) | 28166 | 9389 | 3.00 | 227569 | 84914 | 2.68 | 8.08 | 9.04 | 0.89 |
| F (IE) | 49568 | 23717 | 2.09 | 328962 | 132113 | 2.49 | 6.64 | 5.57 | 1.19 |
| G (IE) | 29664 | 13484 | 2.20 | 270723 | 114229 | 2.37 | 9.13 | 8.47 | 1.08 |

The notation “CE” refers to a comparative first composition, and “IE” to an inventive first composition.

TABLE 5
First Compositions-DSC and Rheology (DMS) Results

| | Tm (° C.) | Heat of | | Viscosity at | Viscosity at | Viscosity | Tan delta at |
|---|---|---|---|---|---|---|---|
| | 2^{nd} | Fusion | | 190° C., 0.1 | 190° C., 100 | Ratio | 190° C., 0.1 |
| | Interpolymer | (J/g) | % cryst. | rad s⁻¹ (Pa · s) | rad s⁻¹ (Pa · s) | (V0.1/V100) | rad s⁻¹ |
| A (IE) | 124.5 | 113.7 | 38.94% | 11,152 | 1,465 | 7.6 | 7.8 |
| B (CE) | 121.9 | 111.5 | 38.18% | 8,986 | 1,559 | 5.8 | 15.0 |
| C (IE) | 122.1 | 114.5 | 39.21% | 12,485 | 1,211 | 10.3 | 4.1 |
| D (CE) | 123.1 | 114.1 | 39.08% | 3,265 | 756 | 4.3 | 15.7 |
| E (IE) | 124.2 | 113.6 | 38.90% | 15,563 | 893 | 17.4 | 2.4 |
| F (IE) | 122.0 | 112.0 | 38.36% | 55,873 | 1,698 | 32.9 | 1.12 |
| G (IE) | 119.5 | 80.5 | 27.55% | 49,104 | 1,480 | 33.2 | 1.40 |

The notation “CE” refers to a comparative first composition, and “IE” to an inventive first composition.

TABLE 6
First Compositions-Density, Melt Index, TMA and Modulus

| | | | | | | Tm (2^{nd} |
|---|---|---|---|---|---|---|
| | | | | | | Interpoly.)/ |
| | | | | TMA | | Density (first |
| | I2* | Density | | Penetration | Microtensile | comp.) |
| First Comp. | (g/10 min) | (g/cc) | I10/I2 | (° C.) | Modulus (MPa) | (° C. × cm³/g) |
| A (IE) | 0.86 | 0.9016 | 9.14 | 119 | 101 | 138.1 |
| B (CE) | 0.92 | 0.9016 | 7.98 | 115 | 101 | 135.2 |
| C (IE) | 0.86 | 0.9023 | 11.35 | 115 | 116 | 135.3 |
| D (CE) | 2.94 | 0.9023 | 9.86 | 115 | 108 | 136.4 |
| E (IE) | 0.90 | 0.9014 | 18.23 | 116 | 89 | 137.8 |
| F (IE) | 0.33 | 0.9004 | 15.40 | NM | 87 | 135.5 |
| G (IE) | 0.29 | 0.8862 | 18.99 | NM | 28 | 134.8 |
| HIFAX CA10A | MFR = 0.6 | — | — | 123 | 60 | |
| IN9010/D2036G | — | 0.900 | — | 120 | — | |
| 58.8/41.2 | | | | | | |

*I2 values shown, except for “HIFAX CA 10A,” which has a melt flow rate (MFR) (230° C./2.16 kg) of 0.6 g/10 min. The notation “CE” refers to a comparative first composition, and “IE” to an inventive first composition.

As seen in Table 6, the first compositions A and E showed the highest TMA-penetration temperatures of 119° C. and 116° C., respectively, among the in-reactor blends. However, each microtensile modulus (101 MPa or 89 MPa) was significantly higher than that of HIFAX CA10A (60 MPa), a commercial thermoplastic polyolefin containing a propylene-based polymer. To improve flexibility (lower modulus), the first compositions were blended with an ethylene/alpha-olefin multi-block copolymer (OBC) as discussed in the section below.

### Blends

The blends shown in Table 7 were prepared by melt blending using a COPERION ZSK 26 mm twin-screw extruder (11-barrel, 44 L/D, electric heating and water cooling). The motor was rated at 40 horsepower. The gearbox ratio was 1:89, and the maximum screw speed was 1,200 RPM. The maximum torque for this line was 106 Nm. The extruder barrel consisted of 11 barrel blocks, linked together. The total length of the barrel was 1125 mm, with a barrel diameter of 26 mm. The following temperature settings were used in the extrusion process: Barrel 2 was heated to 115° C., Barrells 3-11 and the die were heated to 220-230° C. The screw diameter was 25.5 mm. Extruder barrel internal diameter was 26 mm. Nitrogen padding, set at 9.5 SCFH, was always maintained at the feed throat during the entire compounding process. The residence time of each samples was controlled by the screw design, a feed rate of 20 lb/hr, and a 300 RPM screw speed. A K-TRON T-20 single screw polymer feeder was used to feed the polymer mixtures into the extruder's feed throat. The K-TRON feeder was calibrated prior to use. The compounded material exited the extruder through a 4-hole die. The extruded strands were dropped into a 6-foot-long chilled water bath. The strands were then passed through a HUESTIS Air Block to remove excess water. After the strands exited the Air block, they were pelletized with a CONAIR 304 strand pelletizer. The chopped pellets were then dropped into a plastic bag. Samples were purged overnight with nitrogen to dry. Samples were injection molded as discussed below.

### Injection Molding

Test samples were injection molded utilizing a TOYO Si-90 injection molder and universal insert tools that allow different insert to be utilized to make ASTM Type 1 tensile bars or “4 inch×6 inch×0.125 inch” plaques. The tensile bars were used for flexural modulus measurements. The “4 inch×6 inch×0.125 inch” plaques were used for C-Tear, Tensile (with microtensile test samples) and heat resistance (curl analysis). The injection molding conditions are shown in the Table C below.

TABLE C
Injection Molding Conditions

| | | | 4 in. × 6 in. × |
|---|---|---|---|
| | | Type 1 | 0.125 in. |
| Parameters | | tensile bars | plaques |
| Temperatures (° C.) | Nozzle/Set Pt. = 250C | 249 | 249 |
| | Zone 4/Set Pt. = 250C | 250 | 250 |
| | Zone 3/Set Pt. = 250C | 250 | 250 |
| | Zone 2/Set Pt. = 175C | 179 | 178 |
| | Zone 1/Set Pt. = 150C | 150 | 150 |
| | Hopper/Set Pt. = 48C | 56 | 54 |
| Dosage Volume (mm) | | 63 | 122 |
| Inj-Hold Switch-Over | | 15 | 25 |
| Mode (mm) | | | |
| 1st Back-up Timer | | 6 | 6 |
| Injection Pressure (Bar) | | 2000 | 2000 |
| 1st Pressure (i.e., actual | | 632 | 439 |
| max Inj. press) | | | |
| Hold Pressure (Bar) | | 647 | 364 |
| Cushion Volume (mm) | | 8 | 10 |
| Back Pressure (Bar) | | 50 | 50 |
| SuckBack/ | | 5 | 5 |
| Decompression (mm) | | | |
| Temp (° C.) | TCU Set Point | 90 | 90 |
| | Chiller Set Point | 50 | 50 |
| Timers (sec) | Delay Injection | 0 | 0 |
| | Injection Time | 1 | 3 |
| | Holding Time | 25 | 30 |
| | Cooling Time | 20 | 20 |
| | Mold Open | 7 | 7 |
| | Plasticizing Time | 17 | 37 |
| Spd. (in/min) | Plasticizing Speed/ | 90 | 90 |
| | Screw Spd (rpm) | | |
| | Injection Speed (mm/s) | 40 | 40 |
| Part Wt (gm) | | 23 | 50 |
| Cycle Time (sec) | | 58 | 83 |

As discussed above, to improve the flexibility (lower modulus), each first composition was blended with 10% and 20% OBC, as shown in Table 7. Blend properties are shown in Table 8. It is noted that the blends of the first composition with the OBC had lowered overall densities, from 0.902 to 0.895 g/cc, as compared to the densities of the first compositions. As seen in Table 8, the moduli of the blends were comparable to that of HIFAX CA10A (PP TPO), indicating that the blends had good flexibility.

The blends based on first compositions A and E also demonstrated high TMA-penetration temperatures, indicating good heat resistance. Additionally, after the injection molded plaques of the blends were thermally treated at 116° C. in a ventilated oven, under an air atmosphere, for a week, the plaques formed from the blends containing first compositions A and E maintained a flat planar configuration, indicating good dimensional stability and good heat resistance. See Table 8.

### TPO Compositions

A formulation sheet was used to weigh up the ingredients for this experiment. The polymer pellets and additives were weighed up using a METTLER TOLEDO-SG 16001 scale. During weigh up, a 5-gallon bucket with a plastic liner was used to capture the ingredients. Polymer pellets were combined with the CHIMASSORB 2020 in the bucket with a liner. After the weigh up process was completed, the liner was removed, inflated with air, and shaken by hand. The Mg(OH)₂, TiO₂, and IRGANOX B225 were combined in a separate bag using this same method. After the weigh up process was completed, the liner was removed from the bucket, inflated with air, and shaken by hand.

The pellet/CHIMASSORB blends were fed into an extruder using a K-TRON KQX4 single feeder (with no agitator). The Mg(OH)₂, TiO₂, and IRGANOX B225 blends were fed into the extruder using the K-TRON T-20 twin screw feeder (with agitator). The K-TRON feeders were calibrated prior to use. These runs were compounded on the COPERION ZSK 26 twin screw extruder. The motor was rated at 40 horsepower. The gearbox ratio was 1:89, and the maximum screw speed was 1,200 RPM. Maximum torque for this line was 106 Nm. The extruder barrel consisted of 11 barrel blocks, linked together. The total length of the barrel was 1125 mm, with a barrel diameter of 26 mm. The following temperature settings were used in the extrusion process: Barrel 2 was heated to 130° C., Barrells 3-11 and the die were heated to 190° C. the screw diameter was 25.5 mm. Extruder barrel internal diameter was 26 mm. A Nitrogen blanket was used at the feed throat to displace oxygen. The Nitrogen flow meter was set to set to 9.5 SCFH (Standard Cubic Feet per Hour). The residence time of each sample was controlled by the screw design, feed rates of 20 lb/hr, and a screw RPM of 300. A vacuum was maintained at −9 inches of mercury to help remove any trapped air, brought into the extruder by the powders. The compounded material was extruded through a 4-hole die with “4 mm diameter” die holes. Extruded strands passed through a chilled 6-foot-long water bath. The strands were then passed through a HUESTIS Air Block to remove excess water. After the strands passed through the air block, they were pelletized with the CONAIR 304 strand pelletizer. The chopped pellets were dropped into a 20 lb. plastic bags. Samples were N2 purged overnight to dry.

The TPO compositions were extruded into sheets having a thickness of approximately 40 mills, prepared on a Dr. Collin mono layer extrusion cast film line, under the conditions reported in Table D below. The extruder temperature was set at 220° C. to 230° C.

TABLE D
Extruder Conditions

| | |
|---|---|
| Die Total Gap, mils | 45 |
| Air gap, in | 1.5 |
| Film Width, in | 9 |
| Film Thickness, mils | 40 |
| Total Throughput, Kg/h | 9.0 |
| Chill Roll Temperature, ° C. | 30 |
| Melt Temperature, ° C. | 225-230 |
| Melt-Pressure, Bar | 87-130 |
| Screw speed, rpm | 75-84 |

TPO compositions containing the first composition are shown in Table 9. Composition properties are shown in Table 10. As seen in Table 10, the TPO compositions based on the first compositions A and E, had high TMA-penetration temperatures (119° C. and 118° C.), indicating good heat resistance.

TABLE 7
Blends (weight parts)

| Blends | | | | | | INFUSE | INFUSE | DOWLEX | IRGANOX | Target density* |
|---|---|---|---|---|---|---|---|---|---|---|
| (First Comp./OBC) | A | B | C | D | E | 9107 | 9010 | 2036G | B225 | Blend (g/cm³) |
| INFUSE 9010/DOWLEX | | | | | | | 69.9 | 30 | 0.1 | 0.894 |
| 2036G 70/30 | | | | | | | | | | |
| A/INFUSE 9107 (80/20) | 79.9 | | | | | 20 | | | 0.1 | 0.895 |
| A/INFUSE 9107 (90/10) | 89.9 | | | | | 10 | | | 0.1 | 0.898 |
| B/INFUSE 9107 (80/20) | | 79.9 | | | | 20 | | | 0.1 | 0.895 |
| B/INFUSE 9107 (90/10) | | 89.9 | | | | 10 | | | 0.1 | 0.898 |
| C/INFUSE 9107 (80/20) | | | 79.9 | | | 20 | | | 0.1 | 0.895 |
| C/INFUSE 9107 (90/10) | | | 89.9 | | | 10 | | | 0.1 | 0.898 |
| D/INFUSE 9107 (80/20) | | | | 79.9 | | 20 | | | 0.1 | 0.895 |
| D/INFUSE 9107 (90/10) | | | | 89.9 | | 10 | | | 0.1 | 0.898 |
| E/INFUSE 9107 (80/20) | | | | | 79.9 | 20 | | | 0.1 | 0.895 |
| E/INFUSE 9107 (90/10) | | | | | 89.9 | 10 | | | 0.1 | 0.898 |

*Target Density is determined from the following equation below:
ρ = (ρl ρ2)/(ρ1 w2 + ρ2 w1), where ρ is the density of the blend, ρl and w1 are the density and wt. fraction of the first composition, respectively; ρ2 and w2 are the density and wt. fraction of the OBC. The density of the first composition is taken from Table 6.

TABLE 8
Blends-Tensile and other Properties (injection molded)

| | Appearance* | Curl | | TMA | Flex | MD Tensile | % Elongation | Tear MD | Tear CD |
|---|---|---|---|---|---|---|---|---|---|
| Blends | (116° C. for | height | First | (° C.) at-1.0 | Modulus | Modulus | At Break | Total Energy | Total Energy |
| (First Comp./OBC) | 1 wk) | (mm) | Comp. | mm pen | (MPa) | (MPa) | MD | (lbf-in) | (lbf-in) |
| INFUSE 9010/DOWLEX | Flat | 2.0 | | 119 | 101 | 102 | 451 | 110 | 83 |
| 2036G 70/30 | | | | | | | | | |
| A/INFUSE 9107 (80/20) | Flat | 3.0 | A (IE) | 118 | 114 | 91 | 430 | 84 | 60 |
| A/INFUSE 9107 (90/10) | Flat | 4.0 | A (IE) | 119 | 145 | 116 | 443 | 73 | 56 |
| B/INFUSE 9107 (80/20) | Flat | 4.0 | B (CE) | 116 | 126 | 95 | 421 | 61 | 49 |
| B/INFUSE 9107 (90/10) | Slight Curl | 6.0 | B (CE) | 117 | 152 | 117 | 412 | 67 | 51 |
| C/INFUSE 9107 (80/20) | Slight Curl | 7.0 | C (IE) | 114 | 114 | 98 | 426 | 75 | 59 |
| C/INFUSE 9107 (90/10) | Slight Curl | 5.0 | C (IE) | 114 | 144 | 124 | 431 | 78 | 55 |
| D/INFUSE 9107 (80/20) | More Curl | 9.0 | D (CE) | 113 | 117 | 94 | 601 | 79 | 71 |
| D/INFUSE 9107 (90/10) | More Curl | 11.0 | D (CE) | 116 | 157 | 153 | 581 | 81 | 67 |
| E/INFUSE 9107 (80/20) | Flat | 3.0 | E (IE) | 118 | 101 | 94 | 447 | 88 | 69 |
| E/INFUSE 9107 (90/10) | Flat | 4.0 | E (IE) | 119 | 129 | 128 | 450 | 83 | 69 |
| F | Flat | 1.8 | F (IE) | NM | 133 | 184 | 763 | 76 | 65 |
| G | More Curl | 10.5 | G (IE) | NM | 66 | 83 | 767 | 65 | 64 |
| HIFAX CA10A (PP TPO) | Flat | 1.5 | | 128 | 116 | 89 | 400 | 82 | 57 |

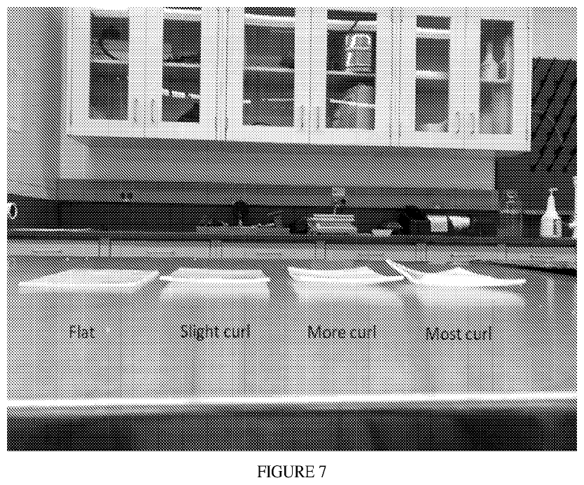

*See FIG. 7 for an example description of each appearance category: flat, slight curl, more curl and severe curl.
F (IE) “as is (no blend)” had a flat appearance after 116° C. for one week.
G (IE) “as is (no blend)” had a more curl appearance after 116° C. for one week.

TABLE 9
TPO Compositions (weight parts)

| TPO | | | | | | | | IN- | IN- | DOW- | | | | IRGA- | |
|---|---|---|---|---|---|---|---|---|---|---|---|---|---|---|---|
| Com- | | | | | | | | FUSE | FUSE | LEX | HIFAX | | | NOX | CHIMASSORB |
| position | A | B | C | D | E | F | G | 9107 | 9010 | 2036G | CA10A | MgOH₂ | TiO₂ | B225 | 2020 |
| INFUSE | | | | | | | | | 51.065 | 21.885 | | 24.0 | 2.4 | 0.15 | 0.50 |
| 9010/ | | | | | | | | | | | | | | | |
| DOWLEX | | | | | | | | | | | | | | | |
| 2036G 70/30 | | | | | | | | | | | | | | | |
| A/INFUSE | 58.36 | | | | | | | 14.59 | | | | 24.0 | 2.4 | 0.15 | 0.50 |
| 9107 (80/20) | | | | | | | | | | | | | | | |
| B/INFUSE | | 58.36 | | | | | | 14.59 | | | | 24.0 | 2.4 | 0.15 | 0.50 |
| 9107 (80/20) | | | | | | | | | | | | | | | |
| C/INFUSE | | | 58.36 | | | | | 14.59 | | | | 24.0 | 2.4 | 0.15 | 0.50 |
| 9107 (80/20) | | | | | | | | | | | | | | | |
| D/INFUSE | | | | 58.36 | | | | 14.59 | | | | 24.0 | 2.4 | 0.15 | 0.50 |
| 9107 (80/20) | | | | | | | | | | | | | | | |
| E/INFUSE | | | | | 58.36 | | | 14.59 | | | | 24.0 | 2.4 | 0.15 | 0.50 |
| 9107 (80/20) | | | | | | | | | | | | | | | |
| F | | | | | | 72.95 | | | | | | 24.0 | 2.4 | 0.15 | 0.50 |
| G | | | | | | | 72.95 | | | | | 24.0 | 2.4 | 0.15 | 0.50 |
| HIFAX | | | | | | | | | | | 72.95 | 24.0 | 2.4 | 0.15 | 0.50 |
| CA10A | | | | | | | | | | | | | | | |

TABLE 10
TPO Compositions-Tensile Properties and other properties

| | TMA | MD Tensile | MD Stress | CD Tensile | CD Stress | Tear MD | Tear CD |
|---|---|---|---|---|---|---|---|
| | (° C.) at-1.0 | Modulus | @ Break | Modulus | @ Break | Total Energy | Total Energy |
| TPO Composition | mm | (MPa) | (MPa) | (MPa) | (MPa) | (lbf-in) | (lbf-in) |
| INFUSE 9010/DOWLEX | 119 | 117 | 22.3 | 52 | 23.2 | 30 | 29 |
| 2036G 70/30 Formulated | | | | | | | |
| A/INFUSE 9107 (80/20) Formulated (IE) | 119 | 176 | 18.4 | 173 | 18.1 | 21 | 19 |
| B/INFUSE 9107 (80/20) Formulated | 117 | 183 | 18.1 | 187 | 18.1 | 18 | 16 |
| C/INFUSE 9107 (80/20) Formulated (IE) | 113 | 150 | 18.0 | 169 | 16.9 | 24 | 18 |
| D/INFUSE 9107 (80/20) Formulated | 114 | 143 | 17.7 | 150 | 18.2 | 30 | 21 |
| E/INFUSE 9107 (80/20) Formulated (IE) | 118 | 129 | 16.7 | 147 | 17.2 | 30 | 19 |
| F Formulated (IE) | NM | 172 | 13.6 | 181 | 10.8 | 16 | 15 |
| G Formulated (IE) | NM | 143 | 12.3 | 68 | 11.5 | 15 | 16 |
| HIFAX CA10A Formulated | 127 | 195 | 18.1 | 133 | 17.1 | 25 | 19 |

1. A composition comprising the following component a):
a) a first composition comprising a first ethylene/alpha-olefin interpolymer and a second ethylene/alpha-olefin interpolymer, and
wherein the first composition comprises the following properties:
i) a density from 0.880 to 0.910 g/cc,
ii) a melt index (I2) from 0.10 to 6.0 g/10 min, and
iii) a tan delta (at 190° C., 0.1 rad/s)≤10.0.

2. The composition of claim 1, wherein the ratio of the M_{w} for the first ethylene/alpha-olefin interpolymer to the M_{w} for the second ethylene/alpha-olefin interpolymer (Mw1/Mw2) is from 6.0 to 10.0.

3. The composition of claim 1, wherein the ratio of the Mn for the first ethylene/alpha-olefin interpolymer to the Mn for the second ethylene/alpha-olefin interpolymer (Mn1/Mn2) is from 5.0 to 10.6.

4. The composition of claim 1, wherein the composition meets the following relationship: [Tm (second interpolymer)/density (first composition)]≥134.0 (° C. cm³/g).

5. The composition of claim 1, wherein the composition meets the following relationship: MWCDI≥6.0

6. The composition of claim 1, wherein the first composition has a molecular weight distribution (MWD=Mw/Mn) from 4.00 to 10.00.

7. The composition of claim 1, wherein the first composition has a z average molecular weight (Mz) from 260,000 to 500,000 g/mol.

8. The composition of claim 1, wherein the first composition has a molecular weight distribution Mz/Mw from 2.10 to 5.00.

9. The composition of claim 1, wherein the first composition is an in-reactor blend.

10. The composition of claim 1, wherein the ratio of the MWD for the first ethylene/alpha-olefin interpolymer to the MWD for the second ethylene/alpha-olefin interpolymer (MWD1/MWD2) from 0.60 to 2.00.

11. The composition of claim 1, wherein the weight ratio of the first ethylene/alpha-olefin interpolymer to the second ethylene/alpha-olefin interpolymer is from 0.80 to 3.00.

12. The composition of claim 1, wherein the difference in the density of the second ethylene/alpha-olefin interpolymer to the density of the first ethylene/alpha-olefin interpolymer (D2-D1) is from 0.060 g/cc to 0.080 g/cc.

13. The composition of claim 1, wherein the composition further comprises an ethylene/alpha-olefin interpolymer or an or ethylene/alpha-olefin multi-block interpolymer, or a combination thereof, as component b.

14. The composition of claim 13, wherein the ratio of the density of the first composition (component a) to the density of the ethylene/alpha-olefin multi-block interpolymer (component b) is from 0.90 to 1.20.

15. The composition of claim 13, wherein the ratio of the I2 of the component a to the I2 of component b (I2First Comp./I2Comp. b) is from 0.10 to 8.50.

16. The composition of claim 13, wherein the composition comprises from 50 wt % to 100 wt % of the sum of components a and b, based on the weight of the composition.

17. The composition of claim 13, wherein a plaque formed from the composition, as described herein, maintains a flat planar, slight curl or more curl configuration after thermal treatment in a ventilated oven at 116° C. for one week.

18. The composition of claim 1, wherein the composition has a heat resistance as determined by TMA value from 116° C. to 125° C.

19. The composition of claim 1, wherein the first composition comprises: ii) a melt index (I2) from 0.10 to 5.3 g/10 min.

20. The composition of claim 1, wherein the second ethylene/alpha-olefin interpolymer has a peak iCCD temperature>80° C.

21. An article comprising at least one component formed from the composition of claim 1.

22. The article of claim 21, wherein the article is a TPO roofing membrane.

23. A method of forming a TPO (thermoplastic polyolefin) composition, said method comprising mixing the composition of claim 1.
